(19) United States
(12) Patent Application Publication
(10) Pub. No.: US 2024/0077373 A1
(43) Pub. Date: Mar. 7, 2024

(54) FORCE SENSOR MODULE

(71) Applicant: SONY GROUP CORPORATION, TOKYO (JP)

(72) Inventors: TOMOKO KATSUHARA, TOKYO (JP); HIDETOSHI MIYASHITA, KUMAMOTO (JP); RUI KAMADA, TOKYO (JP); KIYOKAZU MIYAZAWA, TOKYO (JP); TOSHIMITSU TSUBOI, TOKYO (JP); HAYATO HASEGAWA, TOKYO (JP)

(21) Appl. No.: 18/261,710

(22) PCT Filed: Dec. 16, 2021
(86) PCT No.: PCT/JP2021/046628

§ 371 Date: Jul. 17, 2023

(30) Foreign Application Priority Data
Jan. 27, 2021 (JP) 2021-011470

(51) Int. Cl. G01L 9/00

(52) U.S. Cl. CPC G01L 9/0027

(57) ABSTRACT

A force sensor module according to an embodiment of the present disclosure includes a plurality of force sensors. Each of the force sensor includes a plurality of sensor sections having force detection directions different from each other, and a flexible rubber member that is provided to cover the plurality of sensor sections. The rubber member is configured to transmit a force inputted from outside to the plurality of force sensors by deformation corresponding to the force.

### TECHNICAL FIELD

The present disclosure relates to a force sensor module.

### BACKGROUND ART

In order to control handling of an object by a robot, many sensors are used in the robot. Sensors usable in robots are disclosed, for example, in PTLs 1 and 2 below.

### CITATION LIST

### Patent Literature

PTL 1: US Unexamined Patent Application Publication No. 2016/0167949
PTL 2: Japanese Unexamined Patent Application Publication No. 2015-197357

### SUMMARY OF THE INVENTION

Incidentally, if it becomes possible to dispose a large number of sensors at high density, it becomes possible to obtain various pieces of information difficult to obtain from a single sensor. In particular, in the field of robots, if it becomes possible to dispose a large number of sensors at a tip portion of a robot hand at high density, it also becomes possible to control the robot hand more precisely. It is therefore desirable to provide a force sensor module that is able to be disposed at high density and with high resolution.

A force sensor module according to an embodiment of the present disclosure includes a plurality of force sensors. Each of the force sensor includes a plurality of sensor sections having force detection directions different from each other, and a flexible rubber member that is provided to cover the plurality of sensor sections. The rubber member is configured to transmit a force inputted from outside to the plurality of force sensors by deformation corresponding to the force.

In the force sensor module according to the embodiment of the present disclosure, in each of the force sensors, the force inputted from outside is transmitted to the plurality of sensor sections by deformation of the flexible rubber member that is provided to cover the plurality of sensor sections. This makes it possible to transmit the force from outside to the sensor sections through the rubber member with high sensitivity even in a case where the sensor sections are made small.

### BRIEF DESCRIPTION OF DRAWINGS

FIG. 1 is a diagram illustrating a schematic configuration example of a force sensor module according to a first embodiment of the present disclosure.

FIG. 2 is a diagram illustrating a cross-sectional configuration example of the force sensor module in FIG. 1.

FIG. 3 is a diagram illustrating a planar configuration example of the force sensor module in FIG. 2.

FIG. 4 is a diagram illustrating a circuit configuration example of a diaphragm in FIG. 3.

FIG. 5 is a diagram illustrating a cross-sectional configuration example of a sensor substrate and a force transfer section in FIG. 2.

FIG. 6 is a diagram illustrating an example of a displacement of the force transfer section in FIG. 5.

FIG. 7 (A) of FIG. 7 is a diagram illustrating an example of a displacement of the force transfer section in FIG. 5, and (B) of FIG. 7 is a diagram illustrating an example of a distortion distribution in the sensor substrate when the force transfer section is displaced as illustrated in (A) of FIG. 7.

FIG. 8 is a diagram illustrating a modification example of a circuit configuration of the diaphragm in FIG. 3.

FIG. 9 is a diagram illustrating a modification example of a circuit configuration of the diaphragm in FIG. 3.

FIG. 10 is a diagram illustrating a modification example of a cross-sectional configuration of the force sensor module in FIG. 1.

FIG. 11 (A) of FIG. 11 is a diagram illustrating an example of a displacement of the force transfer section in FIG. 5, and (B) of FIG. 11 is a diagram illustrating an example of a distortion distribution in the sensor substrate when the force transfer section is displaced as illustrated in (A) of FIG. 11.

FIG. 12 is a diagram illustrating a modification example of a cross-sectional configuration of the force sensor module in FIG. 1.

FIG. 13 is a diagram illustrating a modification example of a cross-sectional configuration of the force sensor module in FIG. 1.

FIG. 14 is a diagram illustrating a modification example of a cross-sectional configuration of the force sensor module in FIG. 1.

FIG. 15 is a diagram illustrating a modification example of a cross-sectional configuration of the force sensor module in FIG. 1.

FIG. 16 is a diagram illustrating a modification example of a cross-sectional configuration of the force sensor module in FIG. 1.

FIG. 17 is a diagram illustrating a modification example of a cross-sectional configuration of the force sensor module in FIG. 1.

FIG. 18 is a diagram illustrating a modification example of a cross-sectional configuration of the force sensor module in FIG. 1.

FIG. 19 is a diagram illustrating a top configuration example of the force sensor module in FIG. 18.

FIG. 20 is a diagram illustrating a modification example of a cross-sectional configuration of the force sensor module in FIG. 1.

FIG. 21 is a diagram illustrating a modification example of a cross-sectional configuration of the force sensor module in FIG. 1.

FIG. 22 is a diagram illustrating a modification example of a cross-sectional configuration of the force sensor module in FIG. 1.

FIG. 23 is a diagram illustrating a modification example of a cross-sectional configuration of the force sensor module in FIG. 1.

FIG. 24 is a diagram illustrating a modification example of a cross-sectional configuration of the force sensor module in FIG. 1.

FIG. 25 is a diagram illustrating a modification example of a cross-sectional configuration of the force sensor module in FIG. 1.

FIG. 26 is a diagram illustrating a modification example of a cross-sectional configuration of the force sensor module in FIG. 1.

FIG. 27 is a diagram illustrating a top configuration example of the force sensor module in FIG. 26.

FIG. 28 is a diagram illustrating a modification example of a schematic configuration of the force sensor module in FIG. 1.

FIG. 29 is a diagram illustrating a top configuration example of the force sensor module in FIG. 28.

FIG. 30 is a diagram illustrating a back configuration example of the force sensor module in FIG. 28.

FIG. 31 is a diagram illustrating a modification example of a top configuration of the force sensor module in FIG. 28.

FIG. 32 is a diagram illustrating a modification example of a back configuration of the force sensor module in FIG. 28.

FIG. 33 is a diagram illustrating a schematic configuration example of a force sensor module according to a second embodiment of the present disclosure.

FIG. 34 is a diagram illustrating a cross-sectional configuration example of the force sensor module in FIG. 33.

FIG. 35 is a diagram illustrating a modification example of a cross-sectional configuration of the force sensor module in FIG. 33.

FIG. 36 is a diagram illustrating a modification example of a cross-sectional configuration of the force sensor module in FIG. 33.

FIG. 37 is a diagram illustrating a modification example of a cross-sectional configuration of the force sensor module in FIG. 33.

FIG. 38 is a diagram illustrating a modification example of a cross-sectional configuration of the force sensor module in FIG. 33.

FIG. 39 is a diagram illustrating a modification example of a cross-sectional configuration of the force sensor module in FIG. 33.

FIG. 40 is a diagram illustrating a modification example of a cross-sectional configuration of the force sensor module in FIG. 33.

FIG. 41 is a diagram illustrating a modification example of a cross-sectional configuration of the force sensor module in FIG. 33.

FIG. 42 is a diagram illustrating a modification example of a schematic configuration of the force sensor module in FIG. 33.

FIG. 43 is a diagram illustrating a top configuration example of the force sensor module in FIG. 42.

FIG. 44 is a diagram illustrating a back configuration example of the force sensor module in FIG. 42.

FIG. 45 is a diagram illustrating a modification example of a top configuration of the force sensor module in FIG. 42.

FIG. 46 is a diagram illustrating a modification example of a back configuration of the force sensor module in FIG. 42.

### MODES FOR CARRYING OUT THE INVENTION

Some embodiments of the present disclosure are described below in detail with reference to the drawings. The following description is a specific example of the present disclosure, and the present disclosure is not limited to the following embodiments. In addition, the present disclosure is not limited to arrangements, dimensions, dimension ratios, etc. of respective components illustrated in each drawing. It is to be noted that description is given in the following order.

1. First Embodiment (Key Matrix Force Sensor Module)

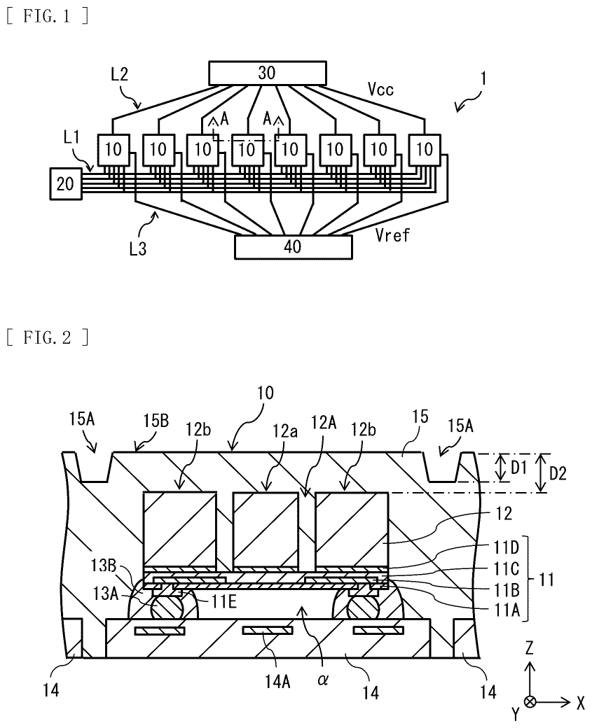

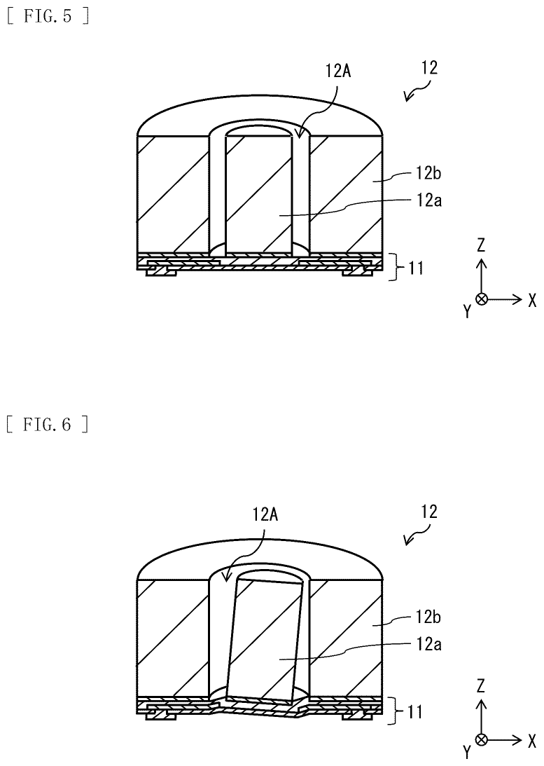

An example in which an input is detected by a key matrix system (FIGS. 1 to 7)

2. Modification Examples of First Embodiment

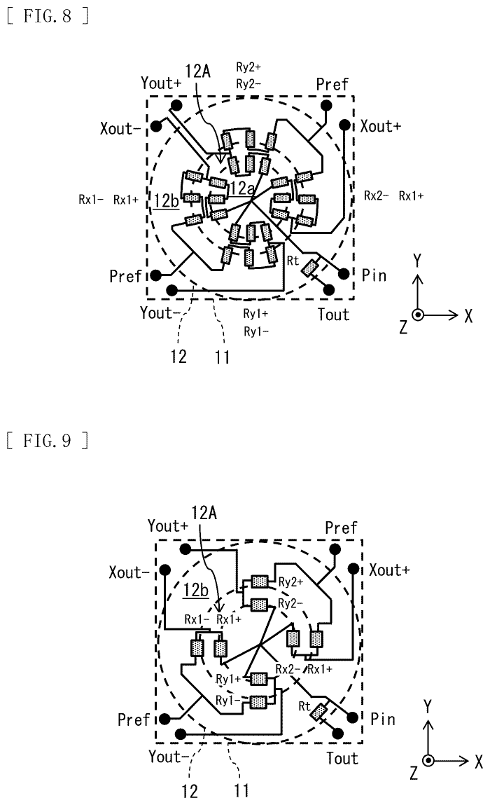

Modification Example 1-1: An example in which resistance layers in a diaphragm are thin and long (FIG. 8)

Modification Example 1-2: An example in which an aspect ratio of the resistance layer in the diaphragm is changed (FIG. 9)

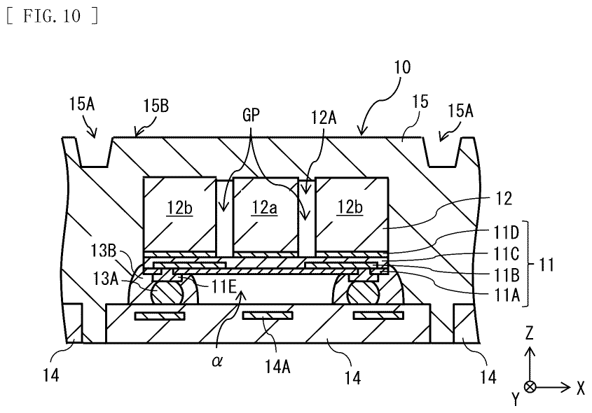

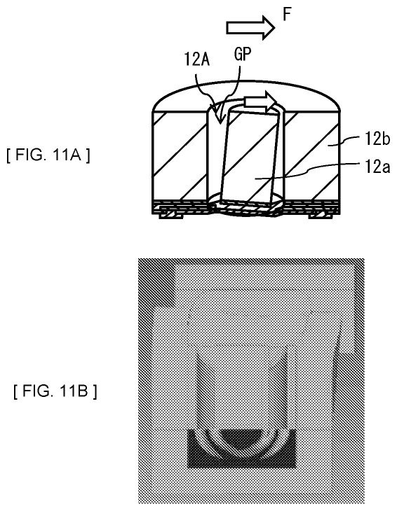

Modification Example 1-3: An example in which an air gap is provided in a groove of a force transfer section (FIGS. 10 and 11)

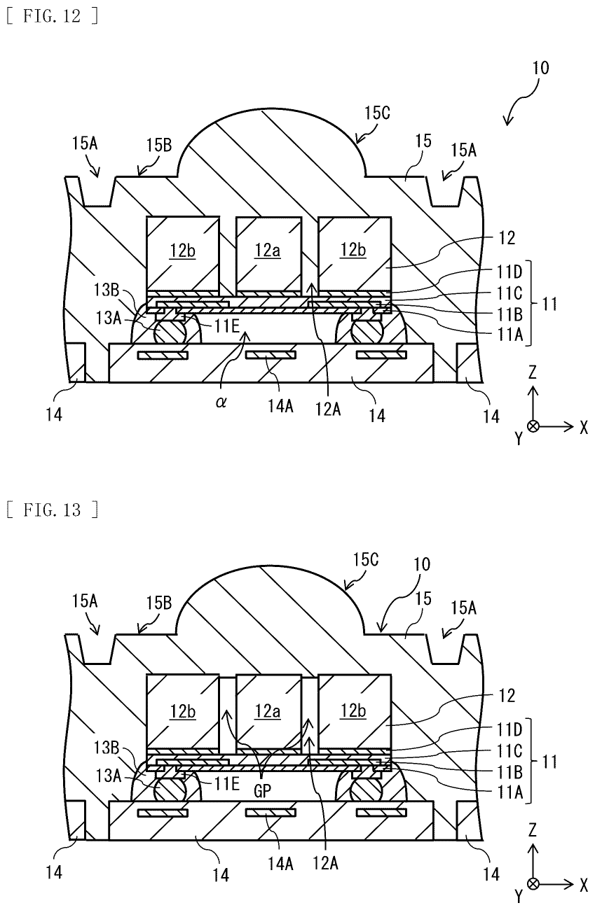

Modification Example 1-4: An example in which a protrusion is provided in an organic member covering the force transfer section (FIGS. 12 and 13)

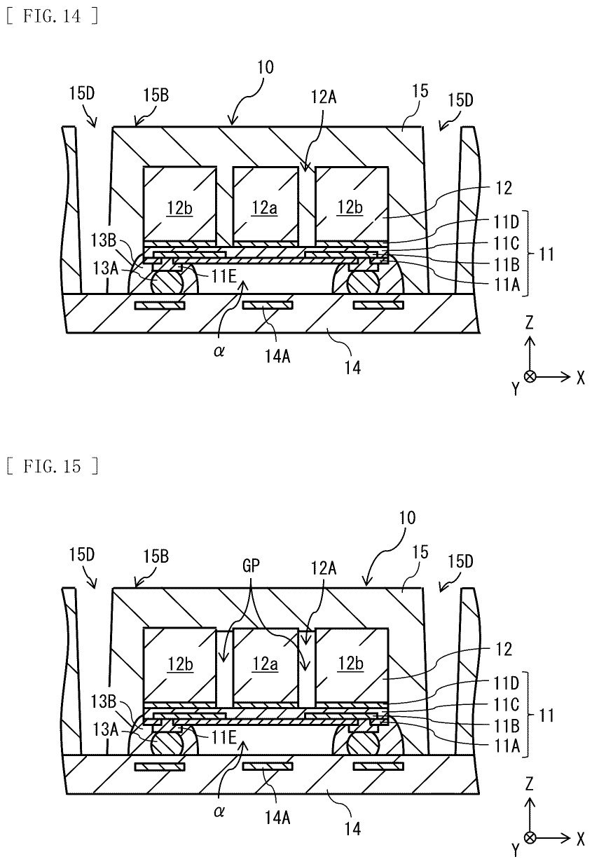

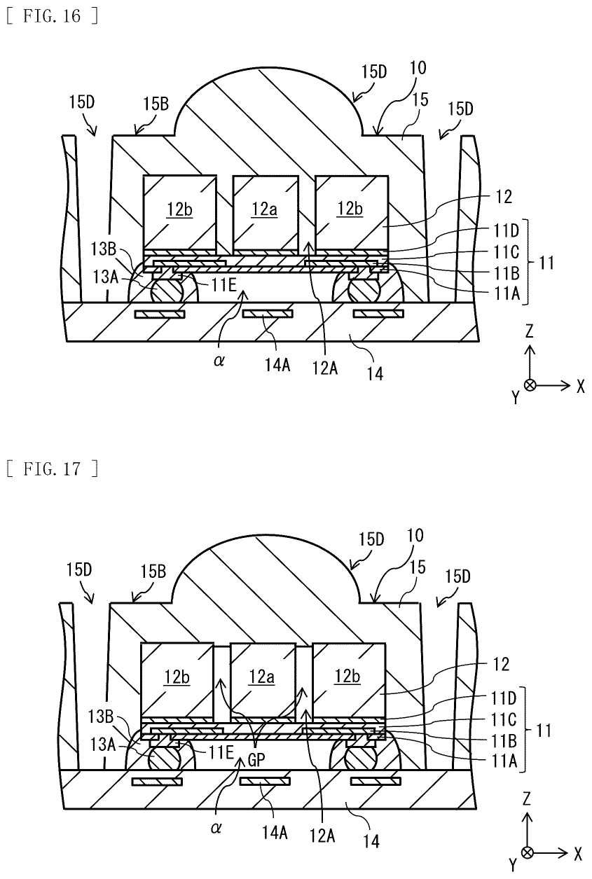

Modification Example 1-5: An example in which the organic member is divided for each force sensor (FIGS. 14 to 17)

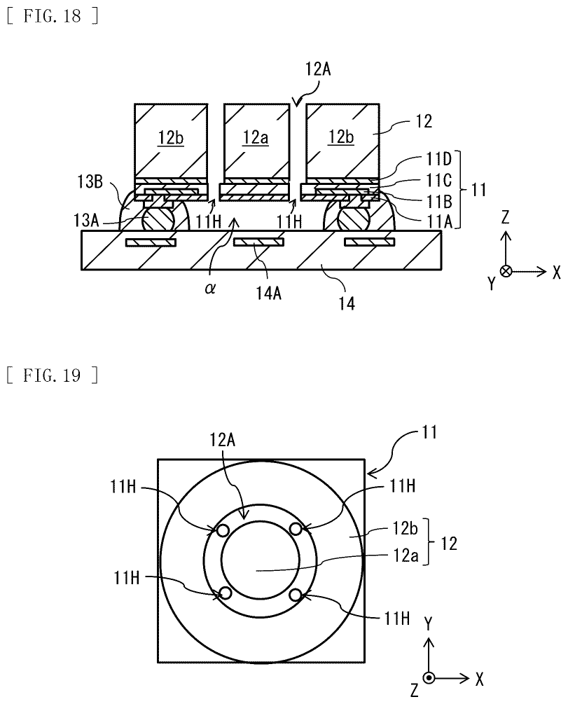

Modification Example 1-6: An example in which a through hole is provided in the sensor substrate (FIGS. 18 and 19)

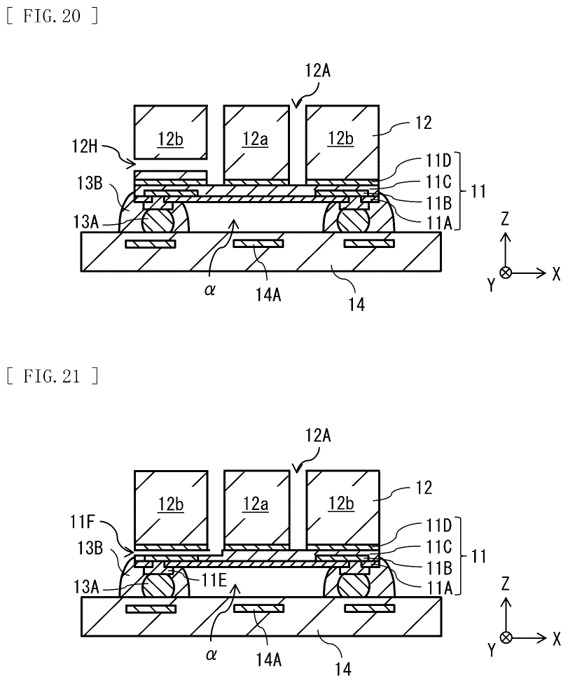

Modification Example 1-7: An example in which a horizontal hole is provided in the force transfer section (FIG. 20)

Modification Example 1-8: An example in which a tunnel is provided in the sensor substrate (FIG. 21)

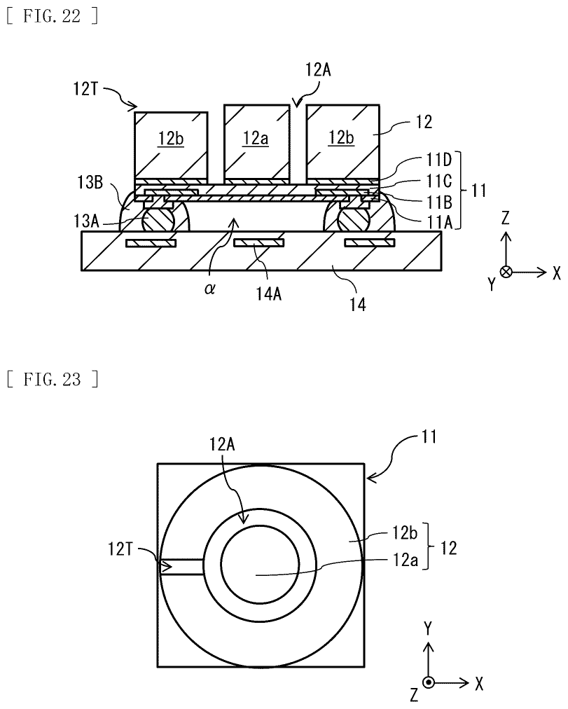

Modification Example 1-9: An example in which a groove is provided in a tube part of the force transfer section (FIGS. 22 and 23)

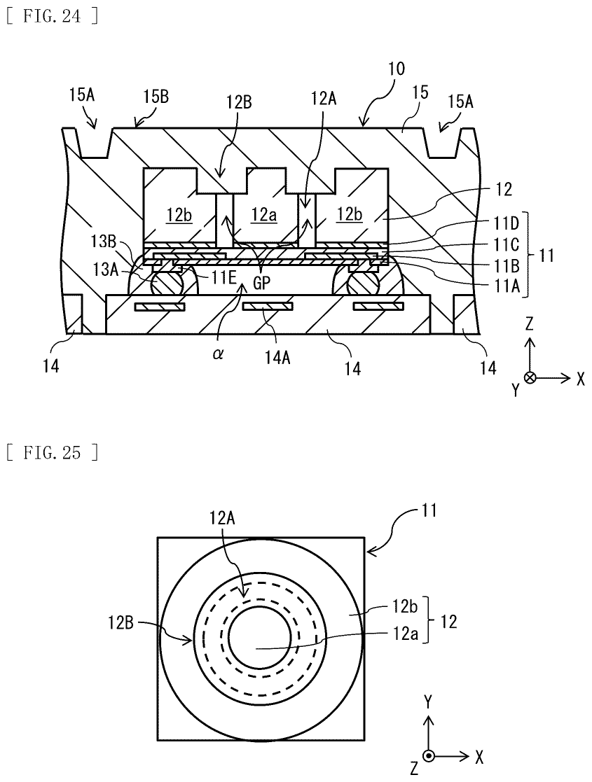

Modification Example 1-10: An example in which a circular notch is provided in the force transfer section (FIGS. 24 and 25)

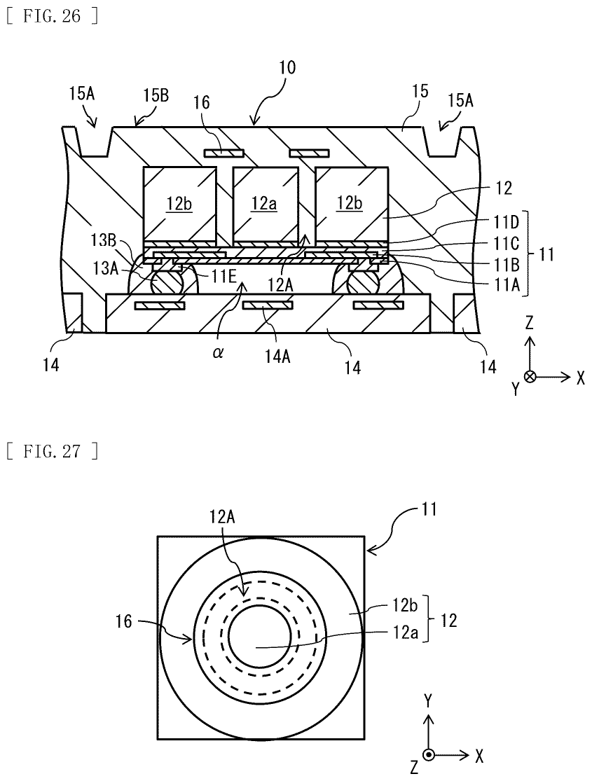

Modification Example 1-11: An example in which a circular force transfer supporting section is provided (FIGS. 26 and 27)

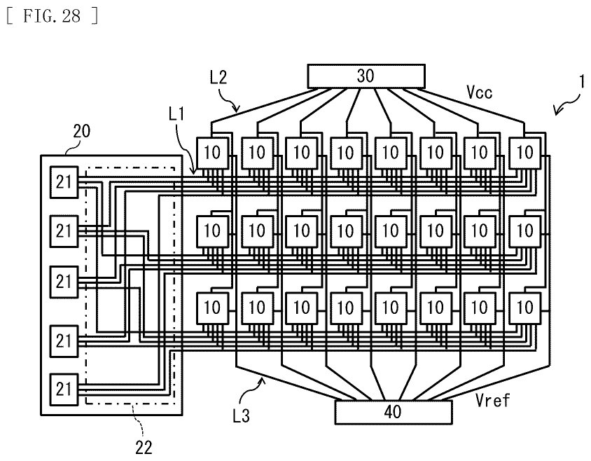

Modification Example 1-12: An example in which a plurality of force sensors is provided in a matrix (FIGS. 28 to 32)

3. Second Embodiment (Daisy Chain Force Sensor Module)

An example in which an input is detected by a daisy chain system (FIGS. 33 and 34)

4. Modification Examples of Second Embodiment

Modification Example 2-1: An example in which resistance layers in a diaphragm are thin and long

Modification Example 2-2: An example in which an aspect ratio of the resistance layer in the diaphragm is changed

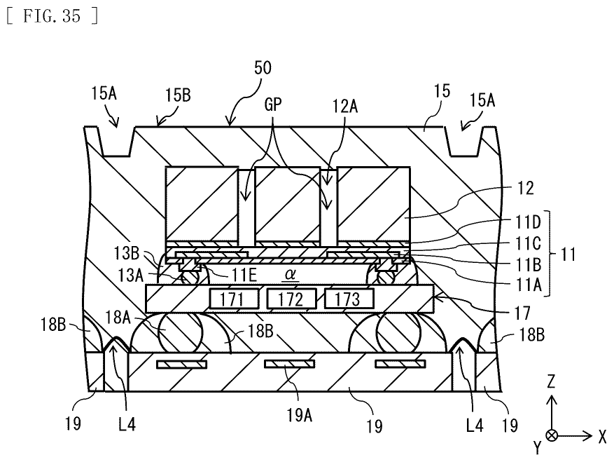

Modification Example 2-3: An example in which an air gap is provided in a groove of a force transfer section (FIG. 35)

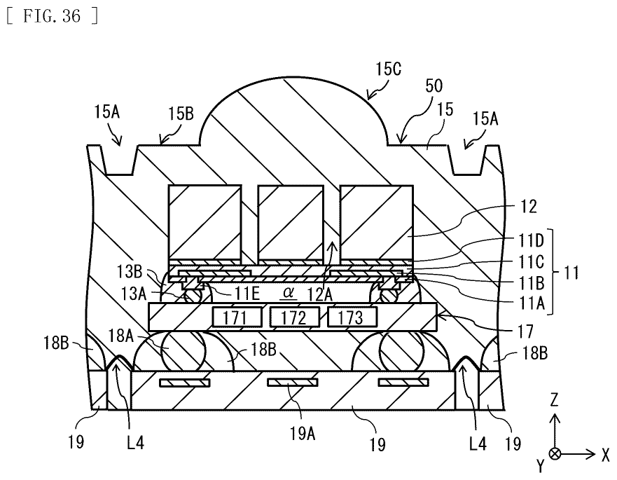

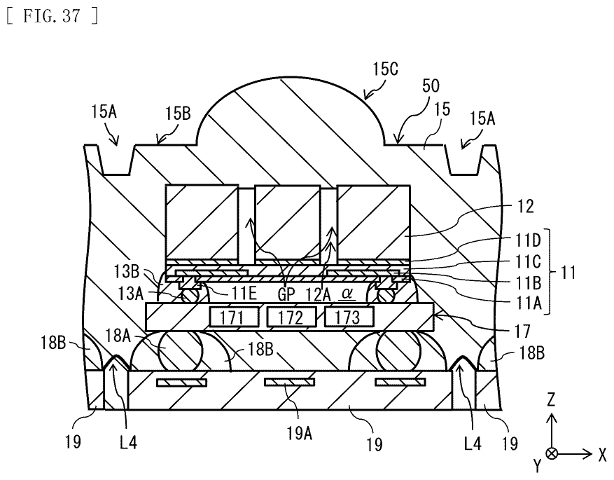

Modification Example 2-4: An example in which a protrusion is provided in an organic member covering the force transfer section (FIGS. 36 and 37)

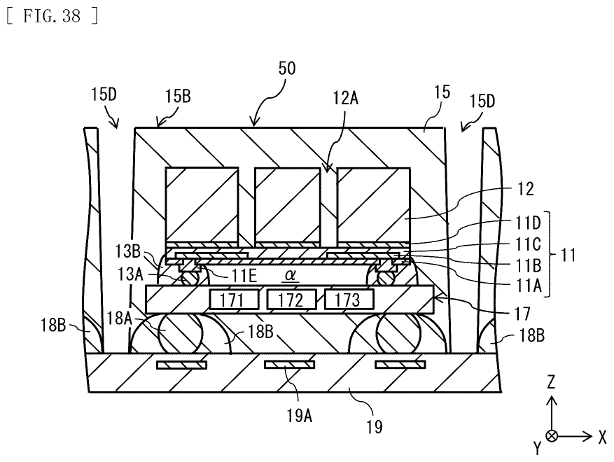

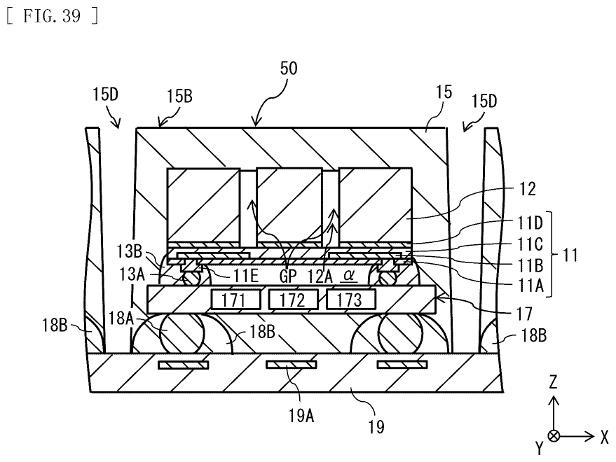

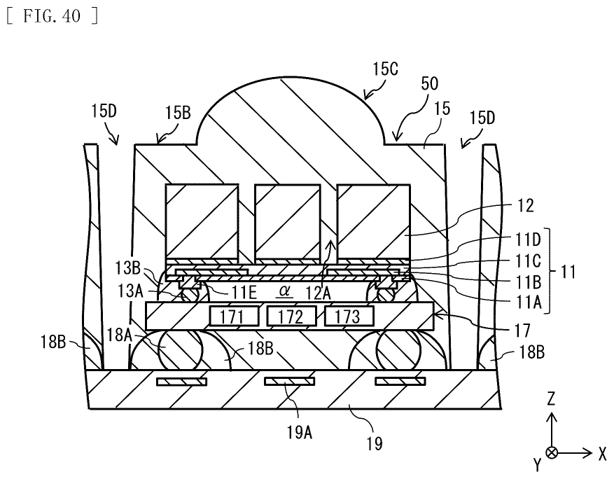

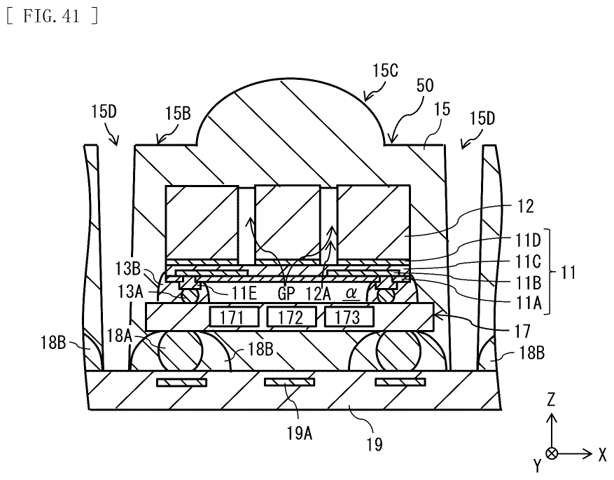

Modification Example 2-5: An example in which the organic member is divided for each force sensor (FIGS. 38 to 41)

Modification Example 2-6: An example in which a through hole is provided in the sensor substrate

Modification Example 2-7: An example in which a horizontal hole is provided in the force transfer section

Modification Example 2-8: An example in which a tunnel is provided in the sensor substrate

Modification Example 2-9: An example in which a groove is provided in a tube part of the force transfer section

Modification Example 2-10: An example in which a circular notch is provided in the force transfer section

Modification Example 2-11: An example in which a circular force transfer supporting section is provided

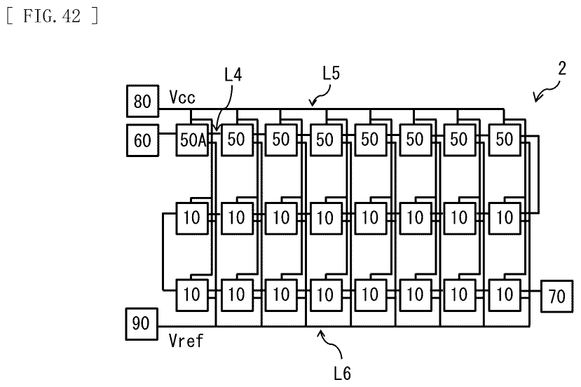

Modification Example 2-12: An example in which a plurality of force sensors is provided in a matrix (FIGS. 42 to 46)

### 1. First Embodiment

### [Configuration]

Description is given of a configuration of a diaphragm type force sensor module 1 according to a first embodiment of the present disclosure. The force sensor module 1 corresponds to a specific example of a “force sensor module” of the present disclosure. FIG. 1 illustrates a schematic configuration example of the force sensor module 1 according to the present embodiment. FIG. 2 illustrates a cross-sectional configuration example of the force sensor module 1 in FIG. 1 taken along a line A-A. FIG. 3 illustrates a portion of a planar configuration example of the force sensor module 1 in FIG. 2 in an enlarged manner. A line A-A in FIG. 3 corresponds to the line A-A in FIG. 1.

The force sensor module 1 includes a plurality of diaphragm type three-axis force sensors 10, a sensor switching circuit 20, a power-voltage supply circuit 30, and a reference voltage supply circuit 40. The diaphragm type three-axis force sensor 10 corresponds to a specific example of a “force sensor” of the present disclosure. The sensor switching circuit 20 includes a multiplexer that selects one of a plurality of sensor wiring lines L1 provided one for each of output terminals included in the diaphragm type three-axis force sensor 10. It is to be noted that in the present embodiment, the plurality of diaphragm type three-axis force sensors 10 is arranged in one row; therefore, in selecting one of the plurality of diaphragm type three-axis force sensors 10, the notion of selecting a row does not exist. The sensor switching circuit 20 outputs a signal of the sensor wiring line L1 selected by the multiplexer to outside. The power-voltage supply circuit 30 includes a multiplexer that selects one of a plurality of power supply lines L2 provided one for each of the diaphragm type three-axis force sensors 10. The power-voltage supply circuit 30 supplies a power supply voltage Vcc to one diaphragm type three-axis force sensor 10 of the plurality of diaphragm type three-axis force sensors 10 through the selected power supply line L2.

The reference voltage supply circuit 40 includes a multiplexer that selects one of a plurality of reference voltage lines L3 provided one for each of the diaphragm type three-axis force sensors 10. The reference voltage supply circuit 40 supplies a reference voltage Vref (e.g., a ground potential) to one diaphragm type three-axis force sensor 10 of the plurality of diaphragm type three-axis force sensors 10 through the reference voltage line L3 selected by the multiplexer. The reference voltage supply circuit 40 couples the reference voltage line L3 selected by the multiplexer to the reference voltage line L3 to supply the power supply voltage Vcc to the diaphragm type three-axis force sensor 10 selected by the power-voltage supply circuit 30. The reference voltage supply circuit 40 floats the reference voltage lines L3 not selected by the multiplexer to prevent the power supply voltage Vcc from being supplied to the respective diaphragm type three-axis force sensors 10 not selected by the power-voltage supply circuit 30.

The diaphragm type three-axis force sensor 10 includes a sensor substrate 11, a force transfer section 12, a wiring board 14, and an organic member 15. The sensor substrate 11 corresponds to s specific example of a “flexible substrate” of the present disclosure. The wiring board 14 corresponds to a specific example of a “wiring board” of the present disclosure. A specific example of the organic member 15 corresponds to a “rubber member” of the present disclosure.

The sensor substrate 11 and the force transfer section 12 are stacked on each other. The force transfer section 12 is provided on the sensor substrate 11. The wiring board 14 is disposed at a position opposed to a lower surface of the sensor substrate 11. The organic member 15 is disposed at a position opposed to an upper surface of the force transfer section 12, and covers the sensor substrate 11 and the force transfer section 12.

The sensor substrate 11 is included in a diaphragm that is able to detect forces of three axes, and includes, for example, an insulating film 11A, a plurality of electrically conductive layers 11B, a flexible substrate 11C, and an insulating film 11D that are stacked in this order from side of the wiring board 14. The plurality of electrically conductive layers 11B corresponds to a specific example of a “plurality of sensor sections having force detection directions different from each other” of the present disclosure. The insulating films 11A and 11D cover the plurality of electrically conductive layers 11B. For example, the insulating films 11A and 11D include SiO₂ or the like. Each of the electrically conductive layers 11B, e.g., sensor sections includes MEMS (Micro Electro Mechanical Systems).

The plurality of electrically conductive layers 11B is provided in contact with a bottom surface of the flexible substrate 11C, and is supported by the flexible substrate 11C. In a case where the flexible substrate 11C includes a thin-film silicon substrate, the plurality of electrically conductive layers 11B is formed, for example, by doping the thin-film silicon substrate with an impurity at a high concentration. For example, the plurality of electrically conductive layers 11B is disposed radially around a middle of the sensor substrate 11 as a center. For example, a portion of each of the electrically conductive layers 11B is provided at a position opposed to a groove 12A to be described later.

Four electrically conductive layers 11B of the plurality of electrically conductive layers 11B include, for example, electrically conductive layers Rx1−, Rx1+, Rx2−, and Rx2+ disposed side by side in an X-axis direction, as illustrated in FIG. 3. The electrically conductive layer Rx1−, Rx1+, Rx2−, and Rx2+ are configured to change resistance values by partial displacements of the electrically conductive layer Rx1−, Rx1+, Rx2−, and Rx2+ in an Z-axis direction. Accordingly, it is possible to detect a force in the X-axis direction by changes in the resistance values of the electrically conductive layers Rx1−, Rx1+, Rx2−, and Rx2+. The electrically conductive layers Rx1−, Rx1+, Rx2−, and Rx2+ each have, for example, a rectangular shape extending in the X-axis direction. Lengths in the X-axis direction of the electrically conductive layers Rx1−, Rx1+, Rx2−, and Rx2+ are longer than lengths in a Y-axis direction of the electrically conductive layer Rx1−, Rx1+, Rx2−, and Rx2+. The electrically conductive layers Rx1− and Rx1+ are provided, for example, in a negative region of an X axis in an XY plane with the middle of the sensor substrate 11 as its origin. The electrically conductive layers Rx2− and Rx2+ are provided, for example, in a positive region of the X axis in the XY plane with the middle of the sensor substrate 11 as its origin.

Four electrically conductive layers 11B of the plurality of electrically conductive layers 11B include, for example, electrically conductive layers Ry1−, Ry1+, Ry2−, and Ry2+ disposed side by side in the Y-axis direction, as illustrated in FIG. 3. The electrically conductive layers Ry1−, Ry1+, Ry2−, and Ry2+ are configured to change resistance values by partial displacements of the electrically conductive layers Ry1−, Ry1+, Ry2−, and Ry2+ in the Z-axis direction. Accordingly, it is possible to detect a force in the Y-axis direction by changes in the resistance values of the electrically conductive layers Ry1−, Ry1+, Ry2−, and Ry2+. The electrically conductive layers Ry1−, Ry1+, Ry2−, and Ry2+ each have, for example, a rectangular shape extending in the Y-axis direction. Lengths in the Y-axis direction of the electrically conductive layers Ry1−, Ry1+, Ry2−, and Ry2+ are longer than lengths in the X-axis direction of the electrically conductive layers Ry1−, Ry1+, Ry2−, and Ry2+. The electrically conductive layer Ry1− and Ry1+ are provided, for example, in a negative region of a Y axis in the XY plane with the middle of the sensor substrate 11 as its origin. The electrically conductive layers Ry2− and Ry2+ are provided, for example, in a positive region of the Y axis in the XY plane with the middle of the sensor substrate 11 as its origin. It is to be noted that it is possible to detect a force in the X-axis direction (that is, a pressing pressure) by changes in the resistance values of the electrically conductive layers Rx1−, Rx1+, Rx2−, Rx2+, Ry1−, Ry1+, Ry2−, and Ry2+.

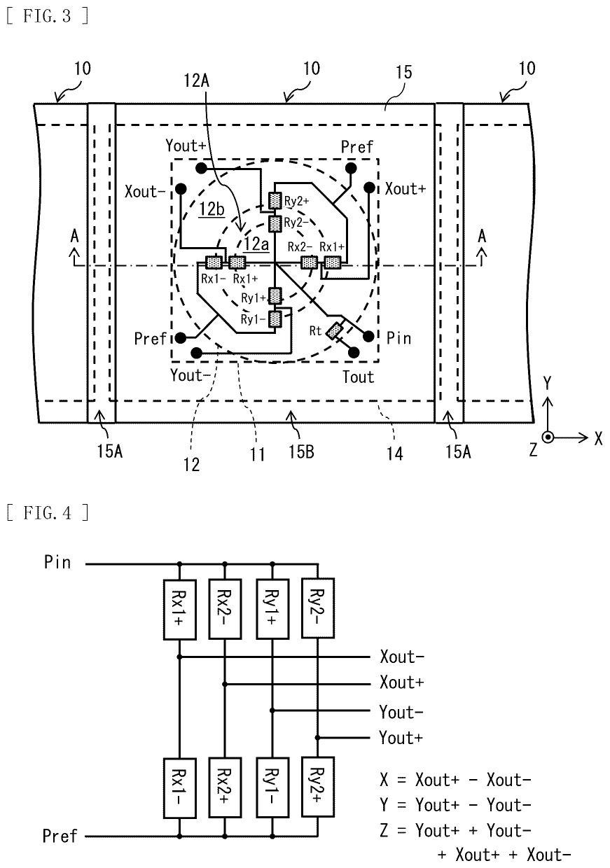

The sensor substrate 11 further includes, for example, four output terminals Xout+, Xout−, Yout+, and Yout−, one power supply voltage terminal Pin, and two reference voltage terminals Pref, as illustrated in FIG. 3. As illustrated in FIGS. 3 and 4, the output terminal Xout+ is coupled to a coupling wiring line that couples the electrically conductive layer Rx2− and the electrically conductive layer Rx2+ to each other, and outputs a voltage of this wiring line to outside. As illustrated in FIGS. 3 and 4, the output terminal Xout− is coupled to a coupling wiring line that couples the electrically conductive layer Rx1− and the electrically conductive layer Rx1+ to each other, and outputs a voltage of this wiring line to outside. As illustrated in FIGS. 3 and 4, the output terminal Yout+ is coupled to a coupling wiring line that couples the electrically conductive layer Rx2− and the electrically conductive layer Rx2+ to each other, and outputs a voltage of this wiring line to outside. As illustrated in FIGS. 3 and 4, the output terminal Yout− is coupled to a coupling wiring line that couples the electrically conductive layer Rx1− and the electrically conductive layer Rx1+ to each other, and outputs a voltage of this wiring line to outside.

As illustrated in FIGS. 3 and 4, the power supply voltage terminal Pin is coupled to a coupling wiring line that couples the electrically conductive layer Rx1+, Rx2−, Ry1+, and Ry2− to each other, and supplies a predetermined voltage (power supply voltage Vcc) to this wiring line. As illustrated in FIGS. 3 and 4, one of the reference voltage terminals Pref is coupled to a coupling wiring line that couples the electrically conductive layer Rx1− and the electrically conductive layer Ry1− to each other, and supplies a predetermined voltage (reference voltage Vref) to this wiring line. As illustrated in FIGS. 3 and 4, the other one of the reference voltage terminals Pref is coupled to a coupling wiring line that couples the electrically conductive layer Rx1+ and the electrically conductive layer Ry2+ to each other, and supplies a predetermined voltage (reference voltage Vref) to this wiring line.

Each of the output terminals Xout+, Xout−, Yout+, and Yout− is coupled to the sensor switching circuit 20 through the sensor wiring line L1. The power supply voltage terminal Pin is coupled to the power-voltage supply circuit 30 through the power supply line L2. Each of the reference voltage terminals Pref is coupled to the reference voltage supply circuit 40 through the reference voltage line L3. Accordingly, for example, as illustrated in FIG. 4, the sensor switching circuit 20 detects a force in the X-axis direction on the basis of signals outputted from the respective output terminals Xout+ and Xout−. In addition, for example, as illustrated in FIG. 4, the sensor switching circuit 20 detects a force in the Y-axis direction on the basis of signals outputted from the respective output terminals Yout+ and Yout−. In addition, for example, as illustrated in FIG. 4, the sensor switching circuit 20 detects a force in the Z-axis direction (pressing pressure) on the basis of signals outputted from the respective output terminal Xout+, Xout−, Yout+, and Yout−.

For example, as illustrated in FIG. 3, one electrically conductive layer 11B of the plurality of electrically conductive layers 11B may be an electrically conductive layer Rt for temperature correction. In this case, for example, as illustrated in FIG. 3, the sensor substrate 11 may further include one output terminal Tout coupled to the power supply voltage terminal Pin through the electrically conductive layer Rt.

As illustrated in FIG. 2, the sensor substrate 11 further includes, for example, eight pad electrodes 11E that are provided one for each terminal of the sensor substrate 11. The pad electrodes 11E include, for example, a metal material such as gold (Au). As illustrated in FIG. 2, the diaphragm type three-axis force sensor 10 further includes, for example, eight bumps 13A that are provided one for each of the pad electrodes 11E, and an underfill 13B for fixing the sensor substrate 11 on the wiring board 14.

The bumps 13A are provided between the sensor substrate 11 and the wiring board 14. The bumps 13A include, for example, a solder material. The underfill 13B is provided at least between the sensor substrate 11 and the wiring board 14. It is preferable that the underfill 13B seal a region (hereinafter referred to as “region α”), opposed to a column part 12a (to be described later) and the groove 12A of the force transfer section 12, of a gap between the sensor substrate 11 and the wiring board 14 to form a hermetically sealed air gap. This makes it possible to facilitate deformation of the sensor substrate 11 by a displacement of the column part 12a (to be described later).

As illustrated in FIGS. 2, 3, and 5, the force transfer section 12 includes, for example, the column part 12a and a tube part 12b. The column part 12a corresponds to a specific example of a “column part” of the present disclosure. The tube part 12b corresponds to a specific example of a “tube part” of the present disclosure. The column part 12a is fixed at a position opposed to the middle of the sensor substrate 11 (a region surrounded by the plurality of electrically conductive layers 11B). The tube part 12b is fixed, on the sensor substrate 11, at a position that is around the column part 12a and has a predetermined gap from the column part 12a. The gap between the column part 12a and the tube part 12b forms the groove 12A. The sensor substrate 11 is exposed at a bottom surface of the groove 12A. A portion of each of the electrically conductive layers 11B included in the sensor substrate 11 is disposed at a position opposed to the bottom surface of the groove 12A. The column part 12a and the tube part 12b are formed, for example, by processing a silicon substrate.

As illustrated in FIG. 2, the wiring board 14 includes, for example, a wiring line 14A for electrically coupling the sensor substrate 11 with the sensor switching circuit 20, the power-voltage supply circuit 30, and the reference voltage supply circuit 40. The wiring board 14 is, for example, a flexible substrate including, for example, the wiring line 14A and a resin layer that supports the wiring line 14A. The sensor substrate 11 and the force transfer section 12 are mounted on an upper surface of the wiring board 14.

The organic member 15 is a flexible organic member that has softness that allows for deformation caused by an external force, and includes a flexible rubber member. Examples of the flexible rubber member include silicone rubber, and the like. The organic member 15 has, for example, a trapezoidal shape. The organic member 15 is provided to cover the plurality of electrically conductive layers 11B, and is able to transmit an external force inputted from outside to the plurality of electrically conductive layers 11B by deformation corresponding to the external force. When an external force is applied to the organic member 15, the organic member 15 is deformed, thereby allowing the organic member 15 to transmit the external force inputted to the organic member 15 to the plurality of electrically conductive layers 11B.

In the present embodiment, the organic member 15 is provided in common to the diaphragm type three-axis force sensors 10, and fixes the plurality of diaphragm type three-axis force sensors 10 in series. The organic member 15 has grooves 15A each formed at a location corresponding to a gap between two sensor substrates 11 adjacent to each other, and has protrusions 15B each formed at a location corresponding to a gap between two grooves 15A adjacent to each other. For example, each of the grooves 15A extends in the Y-axis direction, and partitions the organic member 15 for each diaphragm type three-axis force sensor 10.

The groove 15A is formed at a position shallower than that of the upper surface of the sensor substrate 11. That is, the groove 15A is formed to satisfy the following Expression (1).

D1<D2 Expression (1)
D1: a depth of the groove 15A
D2: a depth of the upper surface of the sensor substrate 11 from a surface of the organic member

The groove 15A suppresses propagation of a force from outside to the diaphragm type three-axis force sensor 10 provided at a position away from an input position. The protrusion 15B makes it easier, when a force is inputted to the organic member 15 from outside, for the force from outside to be inputted to the diaphragm type three-axis force sensor 10 corresponding to the input position. In other words, the organic member 15 has both a function of supporting the plurality of diaphragm type three-axis force sensors 10 in series and a function of selectively inputting a force from outside to the diaphragm type three-axis force sensor 10 corresponding to the input position.

In each of the diaphragm type three-axis force sensors 10, the sensor wiring line L1, the power supply line L2, and the reference voltage line L3 are coupled to the wiring board 14 (specifically, the wiring line 14A). In the force sensor module 1, a gap between two wiring boards 14 adjacent to each other is smaller than an arrangement pitch of the plurality of diaphragm type three-axis force sensors 10. In the force sensor module 1, a gap between two sensor substrates 11 adjacent to each other is smaller than the arrangement pitch of the plurality of diaphragm type three-axis force sensors 10. In the force sensor module 1, the gap between two wiring boards 14 adjacent to each other is smaller than the gap between two sensor substrates 11 adjacent to each other. The arrangement pitch of the plurality of diaphragm type three-axis force sensors 10 is, for example, about 1 mm.

### [Operation]

Next, description is given of an operation of the force sensor module 1.

A control signal is inputted from a control device provided outside to the sensor switching circuit 20, the power-voltage supply circuit 30, and the reference voltage supply circuit 40 through the wiring board 14. Upon inputting the control signal, the power-voltage supply circuit 30 and the reference voltage supply circuit 40 respectively select the power supply line L2 and the reference voltage line L3 corresponding to one diaphragm type three-axis force sensor 10 that is to detect an external force. Accordingly, (the power supply voltage Vcc—the reference voltage Vref) is supplied to the one diaphragm type three-axis force sensor 10 that is to detect the external force. Upon inputting the control signal, the sensor switching circuit 20 selects the sensor wiring line L1 corresponding to the one diaphragm type three-axis force sensor 10 that is to detect the external force. Subsequently, the sensor switching circuit 20 outputs, to the control device provided outside through the selected sensor wiring line L1, respective signals of the output terminals Xout+, Xout−, Yout+, and Yout− in the one diaphragm type three-axis force sensor 10 that is to detect the external force.

In the control device provided outside, an analog signal inputted from the sensor switching circuit 20 is converted into a digital signal, and various kinds of signal processing are performed on the converted signal. For example, the control device provided outside calculates the displacements of the organic member 15 in the three axis directions (the X-axis, the Y-axis, and the Z-axis) caused by the external force on the basis of the signals inputted from the sensor switching circuit 20, and outputs them as measured data to an external circuit.

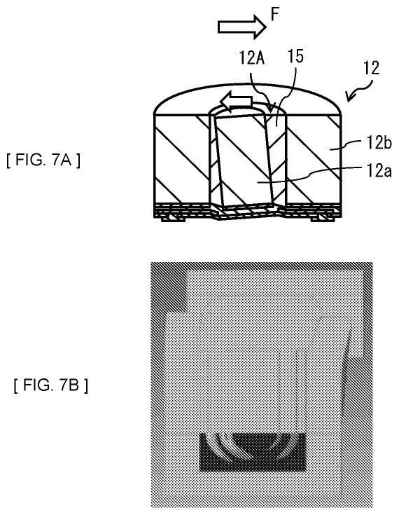

Incidentally, it is assumed that an external force F is applied to the protrusion 15B of the organic member 15, for example, in a direction indicated in (A) of FIG. 7 in performing a detection operation as described above. In this case, a portion of the organic member 15 gets into an end portion of the groove 12A in a vector direction of the external force F. Accordingly, the column part 12a is displaced in a direction opposite to the vector direction of the external force F. As a result, for example, as illustrated in (B) of FIG. 7, a large distortion is generated in a front portion of the sensor substrate 11 in relation to the vector direction of the external force F, and a signal corresponding to the thus-generated distortion is outputted from the sensor substrate 11. The signal outputted from the sensor substrate 11 is outputted to outside through the sensor switching circuit 20 by the detection operation described above.

### [Effects]

Next, description is given of effects of the force sensor module 1.

In the present embodiment, the plurality of diaphragm type three-axis force sensors 10 is disposed in series by the flexible organic member 15. Accordingly, for example, it is possible to dispose the plurality of diaphragm type three-axis force sensors 10 at high density independently of a shape of an installation target. In addition, in the present embodiment, the groove 15A is formed in the organic member 15 at a location corresponding to the gap between the two sensor substrates 11 adjacent to each other. Accordingly, when a force is inputted to the organic member 15 from outside, the force from outside is inputted to the diaphragm type three-axis force sensor 10 corresponding to the input position, and propagation of the force from outside to the diaphragm type three-axis force sensor 10 at a position away from the input position is suppressed. In other words, the organic member 15 has both the function of supporting the plurality of diaphragm type three-axis force sensors 10 in series and the function of selectively inputting a force from outside to the diaphragm type three-axis force sensor 10 corresponding to the input position. Thus, in the present embodiment, it is possible to achieve high-density disposing of the plurality of diaphragm type three-axis force sensors 10 and high-resolution detection by the plurality of diaphragm type three-axis force sensors 10.

In the present embodiment, in each of the electrically conductive layers 11B, a force inputted from outside is transmitted to the plurality of electrically conductive layers 11B by deformation of the flexible rubber member (organic member 15) provided to cover the plurality of electrically conductive layers 11B. Accordingly, even in a case where the electrically conductive layers 11B are made small, it is possible to transmit the force from outside to the electrically conductive layers 11B through the rubber member (organic member 15) with high sensitivity. Thus, in the present embodiment, it is possible to achieve high-density disposing of the plurality of diaphragm type three-axis force sensors 10.

In the present embodiment, a plurality of electrically conductive layers 11B arranged in the X-axis direction and a plurality of electrically conductive layers 11B arranged in the Y-axis direction are provided for each of the diaphragm type three-axis force sensors 10. Accordingly, it is possible to detect inputs of forces in three axis directions (the X-axis direction, the Y-axis direction, and the Z-axis direction), which makes it possible to control, for example, a robot hand precisely.

In the present embodiment, the output terminals Xout−, Xout+, Yout−, and Yout+ are provided. The output terminal Xout− is coupled to a wiring line that couples two electrically conductive layers Rx1− and Rx1+ to each other, and outputs a voltage of this wiring line to outside. The output terminal Xout+ is coupled to a wiring line that couples two electrically conductive layers Rx2− and Rx2+ to each other, and outputs a voltage of this wiring line to outside. The output terminal Yout− is coupled to a wiring line that couples two electrically conductive layers Ry1− and Ry1+ to each other, and outputs a voltage of this wiring line to outside. The output terminal Yout+ is coupled to a wiring line that couples two electrically conductive layers Ry2− and Ry2+ to each other, and outputs a voltage of this wiring line to outside. Accordingly, it is possible to detect inputs of forces in three axis directions (the X-axis direction, the Y-axis direction, and the Z-axis direction), which makes it possible to control, for example, a robot hand precisely.

In the present embodiment, the lengths in the X-axis direction of the electrically conductive layers Rx1−, Rx1+, Rx2−, and Rx2+ are longer than the lengths in the Y-axis direction of the electrically conductive layers Rx1−, Rx1+, Rx2−, and Rx2+. Furthermore, the lengths in the Y-axis direction of the electrically conductive layers Ry1−, Ry1+, Ry2−, and Ry2+ are longer than the lengths in the X-axis direction of the electrically conductive layers Ry1−, Ry1+, Ry2−, and Ry2+. Accordingly, it is possible to detect inputs of forces in three axis directions (the X-axis direction, the Y-axis direction, and the Z-axis direction) with desired detection precision.

In the present embodiment, the electrically conductive layers Rx1−, Rx1+, Rx2−, and Rx2+ are arranged in the X-axis direction, and the electrically conductive layers Ry1−, Ry1+, Ry2−, and Ry2+ are arranged in the Y-axis direction. Accordingly, it is possible to detect inputs of forces in three axis directions (the X-axis direction, the Y-axis direction, and the Z-axis direction), which makes it possible to control, for example, a robot hand precisely.

In the present embodiment, the underfill 13B is provided that seals a region, opposed to the column part 12a and a gap (groove 12A) between the column part 12a and tube part 12b, of the gap between the sensor substrate 11 and the wiring board 14 to form a hermetically sealed air gap. Accordingly, it is possible to facilitate deformation of the sensor substrate 11 by a displacement of the column part 12a. As a result, it is possible to detect inputs of forces in three axis directions (the X-axis direction, the Y-axis direction, and the Z-axis direction) with high sensitivity.

In the present embodiment, the gap between two sensor substrates 11 adjacent to each other is smaller than the arrangement pitch of the plurality of diaphragm type three-axis force sensors 10. This makes it possible to dispose the plurality of diaphragm type three-axis force sensors 10 at high density.

In the present embodiment, the gap between two wiring boards 14 adjacent to each other is smaller than the arrangement pitch of the plurality of diaphragm type three-axis force sensors 10. This makes it possible to dispose the plurality of diaphragm type three-axis force sensors 10 at high density.

### 2. Modification Examples of First Embodiment

Next, description is given of modification examples of the force sensor module 1 according to the first embodiment described above.

### Modification Example 1-1

In the first embodiment described above, a plurality of wiring layers Rx1+ coupled in series may be disposed in parallel, for example, as illustrated in FIG. 8. In this case, each of the wiring layers Rx1+ may be longer and thinner than the wiring layer Rx1+ according to the embodiment described above. In such a case, it is possible to detect a force in the X-axis direction with high sensitivity. In addition, in the first embodiment described above, a plurality of wiring layers Rx1− coupled in series may be disposed in parallel, for example, as illustrated in FIG. 8. In this case, each of the wiring layers Rx1− may be longer and thinner than the wiring layer Rx1− according to the embodiment described above. In such a case, it is possible to detect a force in the X-axis direction with high sensitivity.

In addition, in the first embodiment described above, a plurality of wiring layers Rx2+ coupled in series may be disposed in parallel, for example, as illustrated in FIG. 8. In this case, each of the wiring layers Rx2+ may be longer and thinner than the wiring layer Rx2+ according to the embodiment described above. In such a case, it is possible to detect a force in the X-axis direction with high sensitivity. In addition, in the first embodiment described above, a plurality of wiring layers Rx2− coupled in series may be disposed in parallel, for example, as illustrated in FIG. 8. In this case, each of the wiring layers Rx2− may be longer and thinner than the wiring layer Rx2− according to the embodiment described above. In such a case, it is possible to detect a force in the X-axis direction with high sensitivity.

In addition, in the first embodiment described above, a plurality of wiring layers Ry1+ coupled in series may be disposed in parallel, for example, as illustrated in FIG. 8. In this case, each of the wiring layers Ry1+ may be longer and thinner than the wiring layer Ry1+ according to the embodiment described above. In such a case, it is possible to detect a force in the Y-axis direction with high sensitivity. In addition, in the first embodiment described above, a plurality of wiring layers Ry1− coupled in series may be disposed in parallel, for example, as illustrated in FIG. 8. In this case, each of the wiring layers Ry1− may be longer and thinner than the wiring layer Ry1− according to the embodiment described above. In such a case, it is possible to detect a force in the Y-axis direction with high sensitivity.

In addition, in the first embodiment described above, a plurality of wiring layers Ry2+ coupled in series may be disposed in parallel, for example, as illustrated in FIG. 8. In this case, each of the wiring layers Ry2+ may be longer and thinner than the wiring layer Ry2+ according to the embodiment described above. In such a case, it is possible to detect a force in the Y-axis direction with high sensitivity. In addition, in the first embodiment described above, a plurality of wiring layer Ry2− coupled in series may be disposed in parallel, for example, as illustrated in FIG. 8. In this case, each of the wiring layers Ry2− may be longer and thinner than the wiring layer Ry2− according to the embodiment described above. In such a case, it is possible to detect a force in the Y-axis direction with high sensitivity.

### Modification Example 1-2

In the first embodiment described above and the modification example thereof, for example, as illustrated in FIG. 9, the lengths in the X-axis direction of the electrically conductive layers Rx1−, Rx1+, Rx2−, and Rx2+ may be shorter than the lengths in the Y-axis direction of the electrically conductive layer Rx1−, Rx1+, Rx2−, and Rx2+. Furthermore, for example, as illustrated in FIG. 9, the lengths in the Y-axis direction of the electrically conductive layers Ry1−, Ry1+, Ry2−, and Ry2+ may be shorter than the lengths in the X-axis direction of the electrically conductive layers Ry1−, Ry1+, Ry2−, and Ry2+. In such a case, it is possible to detect inputs of forces in three axis directions (the X-axis direction, the Y-axis direction, and the Z-axis direction) by a signal having a characteristic different from that in the first embodiment described above.

### Modification Example 1-3

In the first embodiment described above and the modification examples thereof, for example, as illustrated in FIG. 10, the air gap GP may be formed in at least a portion in the groove 12A. For example, the groove 12A has a width that prevents a material of the organic member 15 from flowing into the groove 12A in a manufacturing process, which makes it possible to form the air gap GP in at least a portion in the groove 12A.

In the present modification example, it is assumed that the external force F is applied to the protrusion 15B of the organic member 15, for example, in a direction indicated in (A) of FIG. 11 in performing a detection operation similar to that in the first embodiment. In this case, the column part 12a is displaced in the vector direction of the external force F with a displacement of the organic member 15 to which the external force F is applied. As a result, for example, as illustrated in (B) of FIG. 11, a large distortion is generated in a depth portion of the sensor substrate 11 in relation to the vector direction of the external force F, and a signal corresponding to the thus-generated distortion is outputted from the sensor substrate 11. The signal outputted from the sensor substrate 11 is outputted to outside through the sensor switching circuit 20 by the detection operation similar to that in the first embodiment.

In the present modification example, the air gap GP is formed in at least a portion in the groove 12A. Accordingly, it is possible to increase a displacement amount of the column part 12a corresponding to the external force F, as compared with the embodiment described above. As a result, it is possible to perform detection with higher sensitivity, as compared with the embodiment described above.

### Modification Example 1-4

In the first embodiment described above and the modification examples thereof, for example, as illustrated in FIGS. 12 and 13, a dome-shaped protrusion 15C may be provided on the protrusion 15B. The dome-shaped protrusion 15C is provided, for example, at a position opposed to the force transfer section 12. This makes it easy to deform the organic member 15 by the external force F, which makes it possible to transmit an external force to the sensor substrate 11 (the plurality of electrically conductive layers 11B) easily by deformation of the organic member 15. As a result, it is possible to perform detection with higher sensitivity, as compared with the embodiment described above.

### Modification Example 1-5

In the first embodiment described above and the modification examples thereof, for example, as illustrated in FIGS. 14, 15, 16, and 17, the organic member 15 may be provided separately for each diaphragm type three-axis force sensor 10. In this case, in the organic member 15, a groove 15D reaching a surface of the wiring board 14 is formed at a location corresponding to a gap between two sensor substrates adjacent to each other. The wiring board 14 is provided in common to the diaphragm type three-axis force sensors 10, and fixes the plurality of diaphragm type three-axis force sensors 10 in series. Even in such a case, for example, it is possible to dispose the plurality of diaphragm type three-axis force sensors 10 at high density independently of a shape of an installation target.

It is to be noted that in the present modification example, the groove 15D may be formed to have a depth that does not reach the surface of the wiring board 14 and is deeper than that of the groove 15A in the embodiment described above. Even in such a case, for example, it may be possible to dispose the plurality of diaphragm type three-axis force sensors 10 at high density independently of a shape of an installation target.

### Modification Example 1-6

In the first embodiment described above and the modification examples thereof, for example, as illustrated in FIGS. 18 and 19, the sensor substrate 11 may have one or a plurality of through holes 11H that is communicated with the groove 12A. In such a case, for example, when air accumulated in the air gap GP of the groove 12A thermally expands, it is possible to exhaust the air to outside through the one or plurality of through holes 11H. This makes it possible to prevent deformation or breakage of the sensor substrate 11 caused by the air accumulated in the air gap GP.

### Modification Example 1-7

In the first embodiment described above and the modification examples thereof, for example, as illustrated in FIG. 20, the force transfer section 12 may have one or a plurality of horizontal holes 12H that is communicated with the groove 12A and penetrate through the tube part 12b. In such a case, for example, when air accumulated in the air gap GP of the groove 12A thermally expands, it is possible to exhaust the air to outside through the one or plurality of horizontal holes 12H. This makes it possible to prevent deformation or breakage of the sensor substrate 11 caused by the air accumulated in the air gap GP. It is to be noted that the one or plurality of horizontal holes 12H may be a porous region filled with a porous material. Even in such a case, for example, when air accumulated in the air gap GP of the groove 12A thermally expands, it is possible to exhaust the air to outside through the one or plurality of horizontal holes 12H. This makes it possible to prevent deformation or breakage of the sensor substrate 11 caused by the air accumulated in the air gap GP.

### Modification Example 1-8

In the first embodiment described above and the modification examples thereof, for example, as illustrated in FIG. 21, the sensor substrate 11 may have one or a plurality of tunnels 11F (through holes) in the flexible substrate 11C. The one or plurality of tunnels 11F is communicated with the groove 12A and a side surface of the flexible substrate 11C. In such a case, for example, when air accumulated in the air gap GP of the groove 12A thermally expands, it is possible to exhaust the air to outside through the one or plurality of tunnels 11F. This makes it possible to prevent deformation or breakage of the sensor substrate 11 caused by the air accumulated in the air gap GP. It is to be noted that the one or plurality of tunnels 11F may be a porous region filled with a porous material. Even in such a case, for example, when air accumulated in the air gap GP of the groove 12A thermally expands, it is possible to exhaust the air to outside through the one or plurality of tunnels 11F. This makes it possible to prevent deformation or breakage of the sensor substrate 11 caused by the air accumulated in the air gap GP.

### Modification Example 1-9

In the first embodiment described above and the modification examples thereof, for example, as illustrated in FIGS. 22 and 23, the force transfer section 12 may have one or a plurality of grooves 12T that is communicated with the groove 12A and a side surface of the tube part 12b. It can be said that the one or plurality of grooves 12T penetrate through the tube part 12b in the horizontal direction. In such a case, for example, when air accumulated in the air gap GP of the groove 12A thermally expands, it is possible to exhaust the air to outside through the one or plurality of grooves 12T. This makes it possible to prevent deformation or breakage of the sensor substrate 11 caused by the air accumulated in the air gap GP.

### Modification Example 1-10

In the first embodiment described above and the modification examples thereof, for example, as illustrated in FIGS. 24 and 25, the force transfer section 12 may have a circular notch 12B in a circular portion that is in an upper portion of the force transfer section 12 and includes a location opposed to the groove 12A. In such a case, in forming the organic member 15 in a manufacturing process, the material of the organic member 15 is accumulated in the notch 12B, which makes it possible to prevent entry of the material into the groove 12A. As in Modification Example 1-3 described above, providing the air gap GP in a lower portion of the groove 12A in such a manner makes it possible to increase a displacement amount of the column part 12a corresponding to the external force F, as compared with the embodiment described above. As a result, it is possible to perform detection with higher sensitivity, as compared with the embodiment described above.

### Modification Example 1-11

In the first embodiment described above and the modification examples thereof, for example, as illustrated in FIGS. 26 and 27, the force sensor module 1 may include a circular force transfer supporting section 16 at a location that is in the organic member 15 and is opposed to the groove 12A of the force transfer section 12. The force transfer supporting section 16 includes, for example, a metal material such as gold (Au). The force transfer supporting section 16 is provided to transmit the external force F to the column part 12a of the force transfer section 12 as faithfully as possible when the external force F is applied to the organic member 15. In other words, the force transfer supporting section 16 prevents a portion of the organic member 15 from getting into an end portion of the groove 12A in the vector direction of the external force F by the external force F. Providing the force transfer supporting section 16 in such a manner makes it possible to make a signal output pattern corresponding to the external force F common irrespective of whether or not the air gap GP is included in the groove 12A. As a result, it is also possible to make subsequent signal processing common irrespective of whether or not the air gap GP is included in the groove 12A.

### Modification Example 1-12

In the first embodiment described above and the modification examples thereof, for example, as illustrated in FIG. 28, the plurality of diaphragm type three-axis force sensors 10 may be disposed in a matrix. In this case, n sensor wiring lines L1 are allocated to each of rows of the plurality of diaphragm type three-axis force sensors 10 disposed in a matrix. The n sensor wiring lines L1 are coupled to each of the diaphragm type three-axis force sensors 10 disposed in a matrix.

In the present modification example, the sensor switching circuit 20 has, for example, a wiring pattern 22 in which m×n sensor wiring lines L1 coupled to the plurality of diaphragm type three-axis force sensors 10 disposed in a matrix are divided into groups each including m sensor wiring lines L1. The sensor switching circuit 20 further includes, for example, a plurality (n) of multiplexers 21 allocated one to each of the groups. Of the m×n sensor wiring lines L1, m sensor wiring lines L1 are coupled to each of the multiplexers 21. Each of the multiplexers 21 selects one of the m sensor wiring lines L1. In the present modification example, the sensor switching circuit 20 outputs signals of five sensor wiring lines L1 selected by the plurality (n) of multiplexers 21 to outside.

In the present modification example, the power-voltage supply circuit 30 includes a multiplexer that selects one of a plurality of power supply lines L2 provided one for each of columns of the plurality of diaphragm type three-axis force sensors 10 disposed in a matrix. The power-voltage supply circuit 30 supplies the power supply voltage Vcc to a plurality of diaphragm type three-axis force sensors 10 belonging to one column of the plurality of diaphragm type three-axis force sensors 10 disposed in a matrix through the power supply line L2 selected by the multiplexer.

In the present modification example, the reference voltage supply circuit 40 includes a multiplexer that selects one of a plurality of reference voltage lines L3 provided one for each of the columns of the plurality of diaphragm type three-axis force sensors 10 disposed in a matrix. The reference voltage supply circuit 40 supplies the reference voltage Vref (e.g., a ground potential) to a plurality of diaphragm type three-axis force sensors 10 belonging to one column of the plurality of diaphragm type three-axis force sensors 10 disposed in a matrix through the reference voltage line L3 selected by the multiplexer. The reference voltage supply circuit 40 couples the reference voltage line L3 selected by the multiplexer to the reference voltage line L3 to supply the power supply voltage Vcc to a plurality of diaphragm type three-axis force sensors 10 belonging to a column selected by the power-voltage supply circuit 30. The reference voltage supply circuit 40 floats the reference voltage lines L3 not selected by the multiplexer not to supply the power supply voltage Vcc to a plurality of diaphragm type three-axis force sensors 10 belonging to each of columns not selected by the power-voltage supply circuit 30.

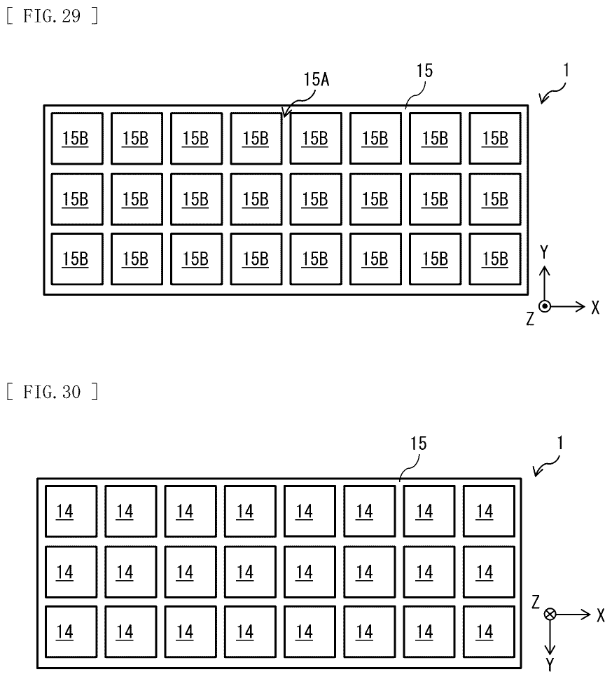

In the present modification example, for example, as illustrated in FIG. 29, the plurality of diaphragm type three-axis force sensors 10 may be partitioned by the groove 15A. In this case, for example, as illustrated in FIG. 30, the wiring board 14 is provided for each of the diaphragm type three-axis force sensors 10, and the wiring boards 14 are fixed to each other in a matrix by the organic member 15.

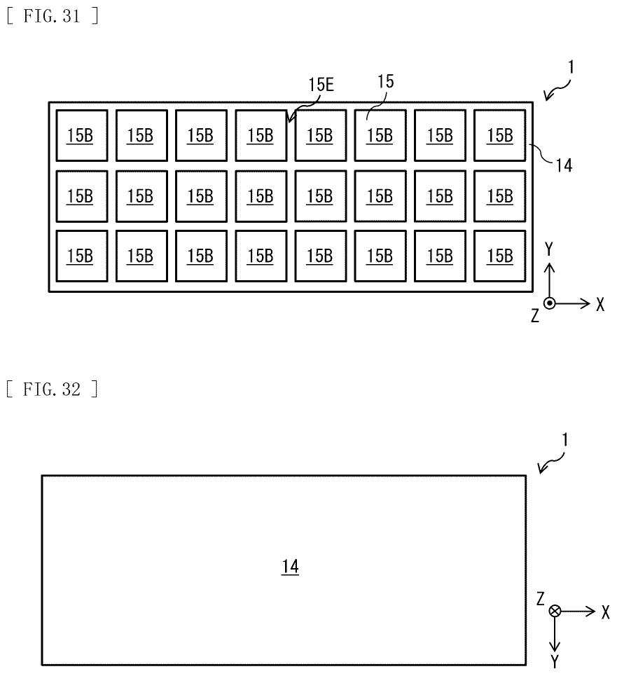

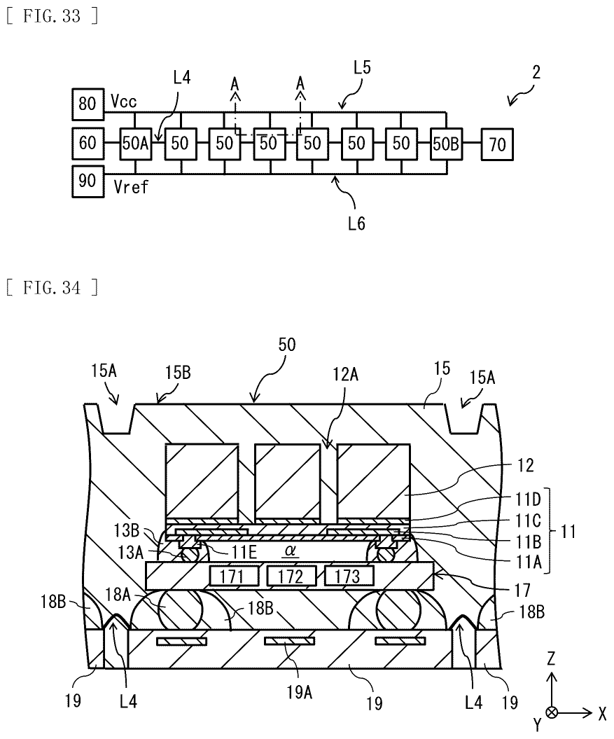

In the present modification example, for example, as illustrated in FIG. 31, the organic member 15 (a plurality of protrusions 15B) may be provided separately for each diaphragm type three-axis force sensor 10. In this case, for example, as illustrated in FIG. 32, the common wiring board 14 is provided for the respective diaphragm type three-axis force sensors 10, and the respective organic members 15 are fixed to each other in a matrix by the wiring board 14. In addition, the plurality of diaphragm type three-axis force sensors 10 is partitioned by the groove 15D reaching the surface of the wiring board 14.

In the present modification example, the plurality of diaphragm type three-axis force sensors 10 is disposed in a matrix. This makes it possible not only to dispose the plurality of diaphragm type three-axis force sensors 10 at high density as in the embodiment described above, but also to simply dispose the plurality of diaphragm type three-axis force sensors 10 in an installation target having a large area.

In the present modification example, a selector that sequentially selects the plurality of diaphragm type three-axis force sensors 10 by simple matrix driving or active matrix driving may be provided in place of the sensor switching circuit 20, the power-voltage supply circuit 30, and the reference voltage supply circuit 40.

### 3. Second Embodiment

### [Configuration]

Description is given of a configuration of a diaphragm force sensor module 2 according to a second embodiment of the present disclosure. The force sensor module 2 corresponds to a specific example of a “force sensor module” of the present disclosure. FIG. 33 illustrates a schematic configuration example of the force sensor module 2 according to the present embodiment. FIG. 34 illustrates a cross-sectional configuration example of the force sensor module 2 in FIG. 33 taken along a line A-A.

The force sensor module 2 includes a plurality of diaphragm type three-axis force sensors 50 coupled in series through a coupling line L4. The coupling line L4 basically includes a clock pair differential line and a data pair differential line, and also includes several kinds of other control lines.

The diaphragm type three-axis force sensor 50 corresponds to the diaphragm type three-axis force sensor 10 in which a circuit board 17 is provided, and a wiring board 19 is provided in place of the wiring board 14. The sensor substrate 11 and the circuit board 17 are stacked on each other. The sensor substrate 11 is disposed at a position opposed to an upper surface of the circuit board 17. The wiring board 19 is disposed at a position opposed to a lower surface of the circuit board 17. The organic member 15 covers the sensor substrate 11 and the circuit board 17.

The circuit board 17 is provided at a position opposed to the sensor substrate 11. The circuit board 17 is a support substrate that supports the sensor substrate 11. The circuit board 17 includes a processing circuit that processes a signal outputted from the sensor substrate 11. The circuit board 17 includes a control circuit 171, a DSP (Digital Signal Processing) circuit 172, and a SerDes (SERializer/DESerializer) circuit 173 as the processing circuits.

The control circuit 171 controls external force detection in the sensor substrate 11 (diaphragm). The control circuit 171 outputs, to the sensor substrate 11 (diaphragm), a signal that controls the external force detection in the sensor substrate 11 (diaphragm). Upon inputting the signal that controls the external force detection from the control circuit 171, the sensor substrate 11 (diaphragm) outputs a signal corresponding to a detected external force.

The DSP circuit 172 processes a signal obtained from the sensor substrate 11 (diaphragm). The DSP circuit 172 performs various kinds of signal processing on a detection signal outputted from the sensor substrate 11 (diaphragm). For example, the DSP circuit 172 calculates displacements of the organic member 15 in three axis directions (the X-axis, the Y-axis, and the Z-axis) caused by an external force, on the basis of the signal outputted from the sensor substrate 11 (diaphragm), and outputs them to outside.

The SerDes circuit 173 performs serial/parallel conversion on a signal inputted from the DSP circuit 172. The SerDes circuit 173 outputs the serial/parallel-converted signal as measured data (packet data) to outside.

A size of the sensor substrate 11 in an XY plane is, for example, smaller than a size of the circuit board 17 in the XY plane. For example, the sensor substrate 11 is stacked on the upper surface of the circuit board 17 with a plurality of bumps 13A interposed therebetween. The sensor substrate 11 is electrically coupled to the circuit board 17 (the control circuit 171 and the DSP circuit 172) through the plurality of bumps 13A.

The wiring board 19 includes a wiring line 19A for electrically coupling an external circuit and the circuit board 17 (the control circuit 171 and the SerDes circuit 173). The wiring board 19 is, for example, a flexible substrate including the wiring line 19A and a resin layer that supports the wiring line 19A. The sensor substrate 11 and the circuit board 17 are mounted on an upper surface of the wiring board 19. For example, the circuit board 17 is stacked on the upper surface of the wiring board 19 with a plurality of bumps 18A interposed therebetween. The bumps 18A include, for example, a solder material. The circuit board 17 is electrically coupled to the wiring board 19 (the wiring line 19A) through the plurality of bumps 18A. The plurality of bumps 18A is covered with, for example, an underfill 18B.

In each of the diaphragm type three-axis force sensors 50, the coupling line L4 and the wiring board 19 (specifically, the wiring line 19A) are coupled to each other, and the coupling line L4 and the circuit board 17 (specifically, the control circuit 171 and the SerDes circuit 173) are electrically coupled to each other. In the force sensor module 2, a gap between two wiring boards 19 adjacent to each other is smaller than an arrangement pitch of the plurality of diaphragm type three-axis force sensors 50. In the force sensor module 2, a gap between two circuit boards 17 adjacent to each other is smaller than the arrangement pitch of the plurality of diaphragm type three-axis force sensors 50. The gap between the two wiring boards 19 adjacent to each other is smaller than the gap between the two circuit boards 17 adjacent to each other. The arrangement pitch of the plurality of diaphragm type three-axis force sensors 50 is, for example, about 1 mm.

As illustrated in FIG. 33, the force sensor module 2 includes, for example, a control device 60. The control device 60 is coupled, through the coupling line L4, to a diaphragm type three-axis force sensor 50 (50A) disposed at one end of the plurality of diaphragm type three-axis force sensors 50 coupled in series. The control device 60 controls external force detection in each of the diaphragm type three-axis force sensors 50. The control device 60 outputs the signal that controls the external force detection in the diaphragm type three-axis force sensor 50 to the diaphragm type three-axis force sensor 50 at a predetermined cycle.

The diaphragm type three-axis force sensor 50A outputs, as packet data, measured data including a signal corresponding to an external force inputted from outside to the diaphragm type three-axis force sensor 50 adjacent to the diaphragm type three-axis force sensor 50A through the coupling line L4 The packet data is inputted from the diaphragm type three-axis force sensor 50A to the diaphragm type three-axis force sensor 50 (hereinafter, referred to as “adjacent sensor”) adjacent to the diaphragm type three-axis force sensor 50A through the coupling line L4. In this case, the adjacent sensor regards this input as a trigger signal to detect the external force, and outputs the measured data including the signal corresponding to the external force as packet data. The adjacent sensor outputs packet data including the measured data obtained by the diaphragm type three-axis force sensor 50A and the measured data obtained by its own measurement to the adjacent diaphragm type three-axis force sensor 50 through the coupling line L4. In the force sensor module 2, control of external force detection and data transmission are thus performed in a bucket relay manner.

For example, as illustrated in FIG. 33, the force sensor module 2 further includes an interface device 70. The interface device 70 is coupled, through the coupling line L4, to a diaphragm type three-axis force sensor 50 (50B) disposed at another end of the plurality of diaphragm type three-axis force sensors 50 coupled in series. The interface device 70 outputs, to outside, a signal obtained by the sensor substrate 11 in each of the diaphragm type three-axis force sensors 50 or a signal (packet data including measured data) corresponding to this signal.

For example, as illustrated in FIG. 33, the force sensor module 2 further includes a power-voltage supply circuit 80 and a reference voltage supply circuit 90. The power-voltage supply circuit 80 supplies the power supply voltage Vcc to the plurality of diaphragm type three-axis force sensors 50 coupled in series. The power-voltage supply circuit 80 supplies the power supply voltage Vcc from side of the diaphragm type three-axis force sensor 50A to the plurality of diaphragm type three-axis force sensors 50 coupled in series through a power supply line L5. The reference voltage supply circuit 90 supplies the reference voltage Vref to the plurality of diaphragm type three-axis force sensors 50 coupled in series. The reference voltage supply circuit 90 supplies the reference voltage Vref from side of the diaphragm type three-axis force sensor 50A to the plurality of diaphragm type three-axis force sensors 50 coupled in series through a reference voltage line L6.

### [Operation]

Next, description is given of an operation of the force sensor module 2.

A signal is inputted from the control device 60 to the control circuit 171 through the wiring board 19. Upon inputting the signal, the control circuit 171 outputs, to the sensor substrate 11, a signal for detecting an external force. Upon inputting the signal for detecting the external force from the control circuit 171, the sensor substrate 11 outputs a signal corresponding to a detected external force to the DSP circuit 172. The DSP circuit 172 performs various kinds of signal processing on the inputted signal. The DSP circuit 172 calculates displacements of the organic member 15 in the three axis directions (the X-axis, the Y-axis, and the Z-axis) caused by the external force, on the basis of the signal outputted from the sensor substrate 11, and outputs them to the SerDes circuit 173. The SerDes circuit 173 performs serial/parallel conversion on a signal inputted from the DSP circuit 172, and outputs packet data as measured data to the interface device 70. The interface device 70 outputs, to outside, a signal obtained by the sensor substrate 11 in each of the diaphragm type three-axis force sensors 50 or a signal (packet data including the measured data) corresponding to this signal. The diaphragm type three-axis force sensor 50 executes the above-described processing each time the signal is inputted from the control device 60.

### [Effects]

Next, description is given of effects of the force sensor module 2.

In the present embodiment, the plurality of diaphragm type three-axis force sensors 50 is disposed in series by the flexible organic member 15. Accordingly, for example, it is possible to dispose the plurality of diaphragm type three-axis force sensors 50 at high density independently of a shape of an installation target. In addition, in the present embodiment, the groove 15A is formed in the organic member 15 at a location corresponding to the gap between the two sensor substrates 11 adjacent to each other. Accordingly, when a force is inputted to the organic member 15 from outside, the force from outside is inputted to the diaphragm type three-axis force sensor 50 corresponding to the input position, and propagation of the force from outside to the diaphragm type three-axis force sensor 50 at a position away from the input position is suppressed. In other words, the organic member 15 has both the function of supporting the plurality of diaphragm type three-axis force sensors 50 in series and the function of selectively inputting a force from outside to the diaphragm type three-axis force sensor 50 corresponding to the input position. Thus, in the present embodiment, it is possible to achieve high-density disposing of the plurality of diaphragm type three-axis force sensors 50 and high-resolution detection by the plurality of diaphragm type three-axis force sensors 50.

In the present embodiment, in each of the electrically conductive layers 11B, a force inputted from outside is transmitted to the plurality of electrically conductive layers 11B by deformation of the flexible rubber member (organic member 15) provided to cover the plurality of electrically conductive layers 11B. Accordingly, even in a case where the electrically conductive layers 11B are made small, it is possible to transmit the force from outside to the electrically conductive layers 11B through the rubber member (organic member 15) with high sensitivity. Thus, in the present embodiment, it is possible to achieve high-density disposing of the plurality of diaphragm type three-axis force sensors 50.

In the present embodiment, a plurality of electrically conductive layers 11B arranged in the X-axis direction and plurality of electrically conductive layers 11B arranged in the Y-axis direction are provided for each of the diaphragm type three-axis force sensors 50. Accordingly, it is possible to detect inputs of forces in three axis directions (the X-axis direction, the Y-axis direction, and the Z-axis direction), which makes it possible to control, for example, a robot hand precisely.

In the present embodiment, the output terminals Xout−, Xout+, Yout−, and Yout+ are provided. The output terminal Xout− is coupled to a wiring line that couples two electrically conductive layers Rx1− and Rx1+ to each other, and outputs a voltage of this wiring line to outside. The output terminal Xout+ is coupled to a wiring line that couples two electrically conductive layers Rx2− and Rx2+ to each other, and outputs a voltage of this wiring line to outside. The output terminal Yout− is coupled to a wiring line that couples two electrically conductive layers Ry1− and Ry1+ to each other, and outputs a voltage of this wiring line to outside. The output terminal Yout+ is coupled to a wiring line that couples two electrically conductive layers Ry2− and Ry2+ to each other, and outputs a voltage of this wiring line to outside. Accordingly, it is possible to detect inputs of forces in three axis directions (the X-axis direction, the Y-axis direction, and the Z-axis direction), which makes it possible to control, for example, a robot hand precisely.

In the present embodiment, the lengths in the X-axis direction of the electrically conductive layers Rx1−, Rx1+, Rx2−, and Rx2+ are longer than the lengths in the Y-axis direction of the electrically conductive layers Rx1−, Rx1+, Rx2−, and Rx2+. Furthermore, the lengths in the Y-axis direction of the electrically conductive layers Ry1−, Ry1+, Ry2−, and Ry2+ are longer than the lengths in the X-axis direction of the electrically conductive layers Ry1−, Ry1+, Ry2−, and Ry2+. Accordingly, it is possible to detect inputs of forces in three axis directions (the X-axis direction, the Y-axis direction, and the Z-axis direction) with desired detection precision.

In the present embodiment, the electrically conductive layers Rx1−, Rx1+, Rx2−, and Rx2+ are arranged in the X-axis direction, and the electrically conductive layers Ry1−, Ry1+, Ry2−, and Ry2+ are arranged in the Y-axis direction. Accordingly, it is possible to detect inputs of forces in three axis directions (the X-axis direction, the Y-axis direction, and the Z-axis direction), which makes it possible to control, for example, a robot hand precisely.

In the present embodiment, the underfill 13B is provided that seals a region, opposed to the column part 12a and a gap (groove 12A) between the column part 12a and the tube part 12b, of the gap between the sensor substrate and the circuit board 17 to form a hermetically sealed air gap. Accordingly, it is possible to facilitate deformation of the sensor substrate 11 by a displacement of the column part 12a. As a result, it is possible to detect inputs of forces in three axis directions (the X-axis direction, the Y-axis direction, and the Z-axis direction) with high sensitivity.

In the present embodiment, the gap between two sensor substrates 11 adjacent to each other is smaller than the arrangement pitch of the plurality of diaphragm type three-axis force sensors 50. This makes it possible to dispose the plurality of diaphragm type three-axis force sensors 50 at high density.

In the present embodiment, the gap between two wiring boards 19 adjacent to each other is smaller than the arrangement pitch of the plurality of diaphragm type three-axis force sensors 50. This makes it possible to dispose the plurality of diaphragm type three-axis force sensors 50 at high density.

### 2. Modification Examples of Second Embodiment

Next, description is given of modification examples of the force sensor module 2 according to the second embodiment described above.

### Modification Example 2-1

In the second embodiment described above, a plurality of wiring layers Rx1+ coupled in series may be disposed in parallel. In this case, each of the wiring layers Rx1+ may be longer and thinner than the wiring layer Rx1+ according to the second embodiment described above. In such a case, it is possible to detect a force in the X-axis direction with high sensitivity. In addition, in the second embodiment described above, a plurality of wiring layers Rx1− coupled in series may be disposed in parallel. In this case, each of the wiring layers Rx1− may be longer and thinner than the wiring layer Rx1− according to the second embodiment described above. In such a case, it is possible to detect a force in the X-axis direction with high sensitivity.

In addition, in the second embodiment described above, a plurality of wiring layers Rx2+ coupled in series may be disposed in parallel. In this case, each of the wiring layers Rx2+ may be longer and thinner than the wiring layer Rx2+ according to the second embodiment described above. In such a case, it is possible to detect a force in the X-axis direction with high sensitivity. In addition, in the second embodiment described above, a plurality of wiring layers Rx2− coupled in series may be disposed in parallel. In this case, each of the wiring layers Rx2− may be longer and thinner than the wiring layer Rx2− according to the second embodiment described above. In such a case, it is possible to detect a force in the X-axis direction with high sensitivity.

In addition, in the second embodiment described above, a plurality of wiring layers Ry1+ coupled in series may be disposed in parallel. In this case, each of the wiring layers Ry1+ may be longer and thinner than the wiring layer Ry1+ according to the second embodiment described above. In such a case, it is possible to detect a force in the Y-axis direction with high sensitivity. In addition, in the second embodiment described above, a plurality of wiring layers Ry1− coupled in series may be disposed in parallel. In this case, each of the wiring layers Ry1− may be longer and thinner than the wiring layer Ry1− according to the second embodiment described above. In such a case, it is possible to detect a force in the Y-axis direction with high sensitivity.

In addition, in the second embodiment described above, a plurality of wiring layers Ry2+ coupled in series may be disposed in parallel. In this case, each of the wiring layers Ry2+ may be longer and thinner than the wiring layer Ry2+ according to the second embodiment described above. In such a case, it is possible to detect a force in the Y-axis direction with high sensitivity. In addition, in the second embodiment described above, a plurality of wiring layer Ry2− coupled in series may be disposed in parallel. In this case, each of the wiring layers Ry2− may be longer and thinner than the wiring layer Ry2− according to the second embodiment described above. In such a case, it is possible to detect a force in the Y-axis direction with high sensitivity.

### Modification Example 2-2

In the second embodiment described above and the modification example thereof, the lengths in the X-axis direction of the electrically conductive layers Rx1−, Rx1+, Rx2−, and Rx2+ may be shorter than the lengths in the Y-axis direction of the electrically conductive layer Rx1−, Rx1+, Rx2−, and Rx2+. Furthermore, the lengths in the Y-axis direction of the electrically conductive layers Ry1−, Ry1+, Ry2−, and Ry2+ may be shorter than the lengths in the X-axis direction of the electrically conductive layers Ry1−, Ry1+, Ry2−, and Ry2+. In such a case, it is possible to detect inputs of forces in three axis directions (the X-axis direction, the Y-axis direction, and the Z-axis direction) by a signal having a characteristic different from that in the second embodiment described above.

### Modification Example 2-3

In the second embodiment described above and the modification examples thereof, for example, as illustrated in FIG. 35, the air gap GP may be formed in at least a portion in the groove 12A. For example, the groove 12A has a width that prevents a material of the organic member 15 from flowing into the groove 12A in a manufacturing process, which makes it possible to form the air gap GP in at least a portion in the groove 12A.

In the present modification example, it is assumed that the external force F is applied to the protrusion 15B of the organic member 15, for example, in a direction illustrated in (A) of FIG. 11 in performing a detection operation similar to that in the second embodiment. In this case, the column part 12a is displaced in the vector direction of the external force F with a displacement of the organic member 15 to which the external force F is applied. As a result, for example, as illustrated in (B) of FIG. 11, a large distortion is generated in a depth portion of the sensor substrate 11 in relation to the vector direction of the external force F, and a signal corresponding to the thus-generated distortion is outputted from the sensor substrate 11. The signal outputted from the sensor substrate 11 is outputted to outside through the interface device 70 by the detection operation similar to that in the second embodiment.

In the present modification example, the air gap GP is formed in at least a portion in the groove 12A. Accordingly, it is possible to increase a displacement amount of the column part 12a corresponding to the external force F, as compared with the second embodiment described above. As a result, it is possible to perform detection with higher sensitivity, as compared with the second embodiment described above.

### Modification Example 2-4

In the second embodiment described above and the modification examples thereof, for example, as illustrated in FIGS. 36 and 37, a dome-shaped protrusion 15C may be provided on the protrusion 15B. The dome-shaped protrusion 15C is provided, for example, at a position opposed to the force transfer section 12. This makes it easy to deform the organic member 15 by the external force F, which makes it possible to transmit an external force to the sensor substrate 11 (the plurality of electrically conductive layers 11B) easily by deformation of the organic member 15. As a result, it is possible to perform detection with higher sensitivity, as compared with the second embodiment described above.

### Modification Example 2-5

In the second embodiment described above and the modification examples thereof, for example, as illustrated in FIGS. 38, 39, 40, and 41, the organic member 15 may be provided separately for each diaphragm type three-axis force sensor 50. In this case, in the organic member 15, a groove 15D reaching a surface of the wiring board 14 is formed at a location corresponding to a gap between two sensor substrates 11 adjacent to each other. The wiring board 19 is provided in common to the diaphragm type three-axis force sensors 50, and fixes the plurality of diaphragm type three-axis force sensors 50 in series. Even in such a case, for example, it is possible to dispose the plurality of diaphragm type three-axis force sensors 50 at high density independently of a shape of an installation target.

It is to be noted that in the present modification example, the groove 15D may be formed to have a depth that does not reach the surface of the wiring board 19 and is deeper than that of the groove 15A in the embodiment described above. Even in such a case, for example, it may be possible to dispose the plurality of diaphragm type three-axis force sensors 50 at high density independently of a shape of an installation target.

### Modification Example 2-6

In the second embodiment described above and the modification examples thereof, the sensor substrate 11 may have one or a plurality of through holes 11H that is communicated with the groove 12A. In such a case, for example, when air accumulated in the air gap GP of the groove 12A thermally expands, it is possible to exhaust the air to outside through the one or plurality of through holes 11H. This makes it possible to prevent deformation or breakage of the sensor substrate 11 caused by the air accumulated in the air gap GP.

### Modification Example 2-7

In the second embodiment described above and the modification examples thereof, the force transfer section 12 may have one or a plurality of horizontal holes 12H that is communicated with the groove 12A and penetrate through the tube part 12b. In such a case, for example, when air accumulated in the air gap GP of the groove 12A thermally expands, it is possible to exhaust the air to outside through the one or plurality of horizontal holes 12H. This makes it possible to prevent deformation or breakage of the sensor substrate 11 caused by the air accumulated in the air gap GP.

### Modification Example 2-8

In the second embodiment described above and the modification examples thereof, the sensor substrate 11 may have one or a plurality of tunnels 11F (through holes) in the flexible substrate 11C. The one or plurality of tunnels 11F is communicated with the groove 12A and a side surface of the flexible substrate 11C. In such a case, for example, when air accumulated in the air gap GP of the groove 12A thermally expands, it is possible to exhaust the air to outside through the one or plurality of tunnels 11F. This makes it possible to prevent deformation or breakage of the sensor substrate 11 caused by the air accumulated in the air gap GP.

### Modification Example 2-9

In the second embodiment described above and the modification examples thereof, the force transfer section 12 may have one or a plurality of grooves 12T that is communicated with the groove 12A and the side surface of the tube part 12b. It can be said that the one or plurality of grooves 12T penetrates through the tube part 12b in the horizontal direction. In such a case, for example, when air accumulated in the air gap GP of the groove 12A thermally expands, it is possible to exhaust the air to outside through the one or plurality of grooves 12T. This makes it possible to prevent deformation or breakage of the sensor substrate 11 caused by the air accumulated in the air gap GP.

### Modification Example 2-10

In the second embodiment described above and the modification examples thereof, the force transfer section 12 may have a circular notch 12B in a circular portion that is in an upper portion of the force transfer section 12 and includes a location opposed to the groove 12A. In such a case, in forming the organic member 15 in a manufacturing process, the material of the organic member 15 is accumulated in the notch 12B, which makes it possible to prevent entry of the material into the groove 12A. As in Modification Example 2-3 described above, providing the air gap GP in a lower portion of the groove 12A in such a manner makes it possible to increase a displacement amount of the column part 12a corresponding to the external force F, as compared with the second embodiment described above. As a result, it is possible to perform detection with higher sensitivity, as compared with the second embodiment described above.

### Modification Example 2-11

In the second embodiment described above and the modification examples thereof, the force sensor module 2 may include a circular force transfer supporting section 16 at a location that is in the organic member 15 and is opposed to the groove 12A of the force transfer section 12. The force transfer supporting section 16 includes, for example, a metal material such as gold (Au). The force transfer supporting section 16 is provided to transmit the external force F to the column part 12a of the force transfer section 12 as faithfully as possible when the external force F is applied to the organic member 15. In other words, the force transfer supporting section 16 prevents a portion of the organic member 15 from getting into an end portion of the groove 12A in the vector direction of the external force F by the external force F. Providing the force transfer supporting section 16 in such a manner makes it possible to make a signal output pattern corresponding to the external force F common irrespective of whether or not the air gap GP is included in the groove 12A. As a result, it is also possible to make subsequent signal processing common irrespective of whether or not the air gap GP is included in the groove 12A.

### Modification Example 2-12

In the second embodiment described above and the modification examples thereof, for example, as illustrated in FIG. 42, the plurality of diaphragm type three-axis force sensors 50 may be disposed in a matrix. In this case, the sensor wiring line L4 has a zigzag serpentine layout. Furthermore, it is preferable that one power supply lines L5 and one reference voltage line L6 be allocated to each column. This prevents a sensor malfunction due to a voltage drop.

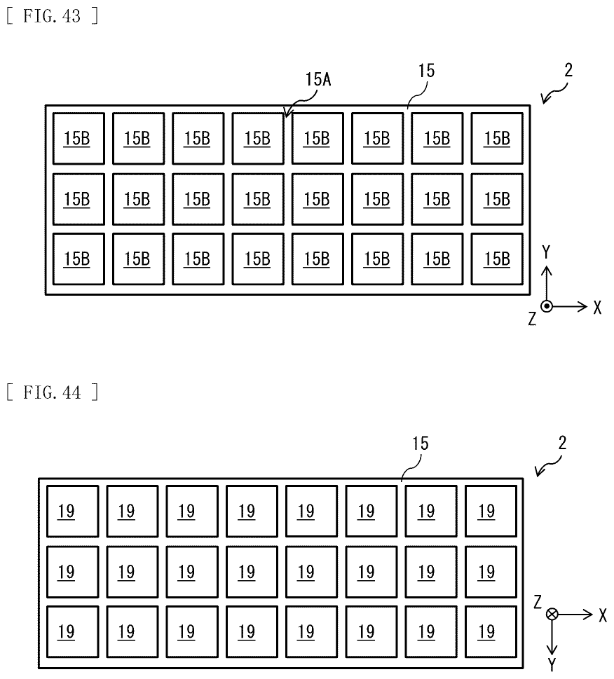

In the present modification example, for example, as illustrated in FIG. 43, the plurality of diaphragm type three-axis force sensors 50 may be partitioned by the groove 15A. In this case, for example, as illustrated in FIG. 44, the wiring board 19 is provided for each of the diaphragm type three-axis force sensors 50, and the wiring boards 19 are fixed to each other in a matrix by the organic member 15.

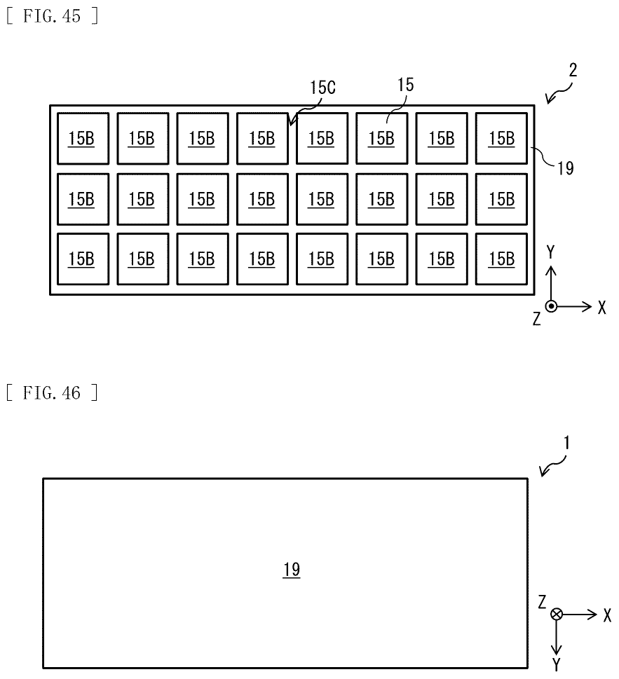

In the present modification example, for example, as illustrated in FIG. 45, the plurality of diaphragm type three-axis force sensors 50 may be partitioned by the groove 15D. In this case, for example, as illustrated in FIG. 46, the common wiring board 19 is provided for the respective diaphragm type three-axis force sensors 50, and the respective organic members 15 are fixed to each other in a matrix by the wiring board 19.

In the present modification example, the plurality of diaphragm type three-axis force sensors 50 is disposed in a matrix. This makes it possible not only to dispose the plurality of diaphragm type three-axis force sensors 50 at higher density as in the second embodiment described above, but also to simply dispose the plurality of diaphragm type three-axis force sensors 50 in an installation target having a large area.

Although the present disclosure has been described above with reference to the embodiments and the modification examples thereof, the present disclosure is not limited to the embodiments and the like described above, and may be modified in a variety of ways. It is to be noted that the effects described herein are merely illustrative. Effects of the present disclosure are not limited to the effects described herein. The present disclosure may have effects other than the effects described herein.

In addition, for example, the present disclosure may have the following configurations.

(1)

A force sensor module including:
a plurality of force sensors,
each of the force sensors including
a plurality of sensor sections having force detection directions different from each other, and
a flexible rubber member that is provided to cover the plurality of sensor sections, and transmits a force inputted from outside to the plurality of force sensors by deformation corresponding to the force.
   (2)

The force sensor module according to (1), in which
in each of the force sensors, the plurality of sensor sections includes a plurality of first sensor sections arranged in a first direction, and a plurality of second sensor sections arranged in a second direction intersecting with the first direction, and
each of the force sensors includes a diaphragm type force sensor including a flexible substrate, a column part, and a tube part, the flexible substrate including the plurality of first sensor sections and the plurality of second sensor sections, the column part being fixed, on the flexible substrate, at a position opposed to a portion of each of the first sensor sections and a portion of each of the second sensor sections, and the tube part being fixed, on the flexible substrate, at a position that is around the column part and has a predetermined gap from the column part.
   (3)

The force sensor module according to (2), in which
each of the force sensors includes
a first coupling wiring line that couples two of the plurality of first sensor sections to each other,
a second coupling wiring line that couples two of the plurality of second sensor sections to each other,
a first output terminal that is coupled to the first coupling wiring line, and outputs a voltage of the first coupling wiring line to outside, and
a second output terminal that is coupled to the second coupling wiring line, and outputs a voltage of the second coupling wiring line to outside.
(4)

The force sensor module according to (3), in which
a length in the first direction of the first sensor section is longer than a length in the second direction of the first sensor section, and
a length in the second direction of the second sensor section is longer than a length in the first direction of the second sensor section.
(5)

The force sensor module according to (3), in which
a length in the first direction of the first sensor section is shorter than a length in the second rection of the first sensor section, and
a length in the second direction of the second sensor section is shorter than a length in the first direction of the second sensor section.
(6)

The force sensor module according to any one of (3) to (5), in which
the plurality of first sensor sections is arranged in the first direction, and
the plurality of second sensor sections is arranged in the second direction.
(7)

The force sensor module according to any one of (2) to (6), in which
each of the force sensors further includes
a plurality of pad electrodes that is electrically coupled to the plurality of sensor sections, and is provided in an outer edge portion of a back surface of the flexible substrate,
a wiring board that is electrically coupled to the plurality of pad electrodes through solder, and supports the flexible substrate, and
an underfill that seals a region, opposed to the column part and a gap between the column part and the tube part, of a gap between the flexible substrate and the wiring board to form an air gap.
   (8)

The force sensor module according to (7), in which
the plurality of force sensors is disposed in a matrix, and
the force sensor module further includes:
a plurality of sensor wiring lines of which n sensor wiring lines are coupled to each of rows of the plurality of force sensors;
a plurality of power supply lines coupled one by one to columns of the plurality of force sensors;
a first selector that selects one of the n sensor wiring lines for each row; and
a second selector that selects one of the plurality of power supply lines.
   (9)

The force sensor module according to (7), in which
the plurality of force sensors is disposed in a matrix, and
the force sensor module further includes a selector that sequentially selects one of the plurality of force sensors by simple matrix driving or active matrix driving.
   (10)

The force sensor module according to any one of (2) to (6), in which
each of the force sensors further includes
a plurality of pad electrodes that is electrically coupled to the plurality of sensor sections, and is provided in an outer edge portion of a back surface of the flexible substrate,
a circuit board that is electrically coupled to the plurality of pad electrodes through solder, supports the flexible substrate, and includes a processing circuit that processes a detection signal outputted from each of the plurality of sensor sections, and
an underfill that seals a region, opposed to the column part and a gap between the column part and the tube part, of a gap between the flexible substrate and the circuit board to form an air gap.
   (11)

The force sensor module according to (10), in which
the plurality of force sensor is electrically coupled in series, and
the force sensor module further includes:
a control device that is coupled to a first force sensor disposed at one end of the plurality of force sensors coupled in series, and controls the plurality of sensor sections in each of the force sensors; and
an interface device that is coupled to a second force sensor disposed at another end of the plurality of force sensors coupled in series, and outputs, to outside, a detection signal obtained by the plurality of sensor sections in each of the force sensors or a signal corresponding to the detection signal.
   (12)

The force sensor module according to any one of (2) to (11), in which at least a portion of the gap has an air gap.

(13)

The force sensor module according to (12), in which the flexible substrate has one or a plurality of through holes that is communicated with the gap.

(14)

The force sensor module according to (12), in which the tube part has one or a plurality of horizontal holes that is communicated with the gap and penetrates through the tube part.

(15)

The force sensor module according to (12), in which the tube part includes one or a plurality of porous regions that penetrates through the tube part.

(16)

The force sensor module according to any one of (1) to (15), in which the sensor section includes a MEMS (Micro Electro Mechanical Systems).

According to a force sensor module according to an embodiment of the present disclosure, in each of force sensors, a force inputted from outside is transmitted to a plurality of sensor sections by deformation of a flexible rubber member that is provided to cover the plurality of sensor sections, which makes it possible to transmit the force from outside to the sensor sections through the rubber member with high sensitivity even in a case where the sensor sections are made small. As a result, it is possible to dispose a plurality of force sensors at high density. It is to be noted that the effects of the present disclosure are not necessarily limited to the effects described above and may be any of the effects described herein.

This application claims the priority on the basis of Japanese Patent Application No. 2021-011470 filed on Jan. 27, 2021 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. A force sensor module comprising:
a plurality of force sensors,
each of the force sensors including
a plurality of sensor sections having force detection directions different from each other, and
a flexible rubber member that is provided to cover the plurality of sensor sections, and transmits a force inputted from outside to the plurality of force sensors by deformation corresponding to the force.

2. The force sensor module according to claim 1, wherein
in each of the force sensors, the plurality of sensor sections includes a plurality of first sensor sections arranged in a first direction, and a plurality of second sensor sections arranged in a second direction intersecting with the first direction, and
each of the force sensors comprises a diaphragm type force sensor including a flexible substrate, a column part, and a tube part, the flexible substrate including the plurality of first sensor sections and the plurality of second sensor sections, the column part being fixed, on the flexible substrate, at a position opposed to a portion of each of the first sensor sections and a portion of each of the second sensor sections, and the tube part being fixed, on the flexible substrate, at a position that is around the column part and has a predetermined gap from the column part.

3. The force sensor module according to claim 2, wherein
each of the force sensors includes
a first coupling wiring line that couples two of the plurality of first sensor sections to each other,
a second coupling wiring line that couples two of the plurality of second sensor sections to each other,
a first output terminal that is coupled to the first coupling wiring line, and outputs a voltage of the first coupling wiring line to outside, and
a second output terminal that is coupled to the second coupling wiring line, and outputs a voltage of the second coupling wiring line to outside.

4. The force sensor module according to claim 3, wherein
a length in the first direction of the first sensor section is longer than a length in the second direction of the first sensor section, and
a length in the second direction of the second sensor section is longer than a length in the first direction of the second sensor section.

5. The force sensor module according to claim 3, wherein
a length in the first direction of the first sensor section is shorter than a length in the second rection of the first sensor section, and
a length in the second direction of the second sensor section is shorter than a length in the first direction of the second sensor section.

6. The force sensor module according to claim 3, wherein
the plurality of first sensor sections is arranged in the first direction, and
the plurality of second sensor sections is arranged in the second direction.

7. The force sensor module according to claim 2, wherein
each of the force sensors further includes
a plurality of pad electrodes that is electrically coupled to the plurality of sensor sections, and is provided in an outer edge portion of a back surface of the flexible substrate,
a wiring board that is electrically coupled to the plurality of pad electrodes through solder, and supports the flexible substrate, and
an underfill that seals a region, opposed to the column part and a gap between the column part and the tube part, of a gap between the flexible substrate and the wiring board to form an air gap.

8. The force sensor module according to claim 7, wherein
the plurality of force sensors is disposed in a matrix, and
the force sensor module further comprises:
a plurality of sensor wiring lines of which n sensor wiring lines are coupled to each of rows of the plurality of force sensors;
a plurality of power supply lines coupled one by one to columns of the plurality of force sensors;
a first selector that selects one of the n sensor wiring lines for each row; and
a second selector that selects one of the plurality of power supply lines.

9. The force sensor module according to claim 7, wherein
the plurality of force sensors is disposed in a matrix, and
the force sensor module further comprises a selector that sequentially selects one of the plurality of force sensors by simple matrix driving or active matrix driving.

10. The force sensor module according to claim 2, wherein
each of the force sensors further includes
a plurality of pad electrodes that is electrically coupled to the plurality of sensor sections, and is provided in an outer edge portion of a back surface of the flexible substrate,
a circuit board that is electrically coupled to the plurality of pad electrodes through solder, supports the flexible substrate, and includes a processing circuit that processes a detection signal outputted from each of the plurality of sensor sections, and
an underfill that seals a region, opposed to the column part and a gap between the column part and the tube part, of a gap between the flexible substrate and the circuit board to form an air gap.

11. The force sensor module according to claim 10, wherein
the plurality of force sensor is electrically coupled in series, and
the force sensor module further comprises:
a control device that is coupled to a first force sensor disposed at one end of the plurality of force sensors coupled in series, and controls the plurality of sensor sections in each of the force sensors; and
an interface device that is coupled to a second force sensor disposed at another end of the plurality of force sensors coupled in series, and outputs, to outside, a detection signal obtained by the plurality of sensor sections in each of the force sensors or a signal corresponding to the detection signal.

12. The force sensor module according to claim 2, wherein at least a portion of the gap has an air gap.

13. The force sensor module according to claim 12, wherein the flexible substrate has one or a plurality of through holes that is communicated with the gap.

14. The force sensor module according to claim 12, wherein the tube part has one or a plurality of horizontal holes that is communicated with the gap and penetrates through the tube part.

15. The force sensor module according to claim 12, wherein the tube part includes one or a plurality of porous regions that penetrates through the tube part.

16. The force sensor module according to claim 1, wherein the sensor section includes a MEMS (Micro Electro Mechanical Systems).
